(19) United States
(12) Patent Application Publication
(10) Pub. No.: US 2024/0150574 A1
(43) Pub. Date: May 9, 2024

(54) POLYCARBONATE RESIN COMPOSITION

(71) Applicant: IDEMITSU KOSAN CO.,LTD., Tokyo (JP)

(72) Inventors: Takahiro TORII, Taipei City (TW); Yasunobu YAMAZAKI, Chiba-shi (CN)

(73) Assignee: IDEMITSU KOSAN CO.,LTD., Tokyo (JP)

(21) Appl. No.: 18/393,248

(22) Filed: Dec. 21, 2023

Related U.S. Application Data
(62) Division of application No. 17/274,929, filed on Mar. 10, 2021.

(30) Foreign Application Priority Data
Sep. 14, 2018 (JP) 2018-173124

(51) Int. Cl. C08L 69/00; C08G 64/04; C08K 5/00; C08K 5/1515; C08K 5/42; C08K 5/527; C08L 27/18; C08L 71/02

(52) U.S. Cl. CPC C08L 69/00; C08G 64/04; C08K 5/005; C08K 5/1515; C08K 5/42; C08K 5/527; C08L 27/18; C08L 71/02; C08G 2261/132; C08L 2201/02; C08L 2201/50; C08L 2205/03

(57) ABSTRACT

Provided is a polycarbonate-based resin composition, including; a polycarbonate-based resin (A) having a branching ratio of 0.01 mol % or more and 3.0 mol % or less; and a diphosphite compound (B) having a specific structure, wherein a content of the diphosphite compound (B) is from 0.005 part by mass to 0.5 part by mass with respect to 100 parts by mass of the polycarbonate-based resin (A).

### CROSS-REFERENCE TO RELATED APPLICATIONS

The present application is a Divisional of U.S. patent application Ser. No. 17/274,929, filed on Mar. 10, 2021, which claims priority under 35 U.S.C. § 371 to International Patent Application No. PCT/JP2019/035598, filed Sep. 11, 2019, which claims priority to Japanese Patent Application No. 2018-173124, filed on Sep. 14, 2018. The contents of these applications are hereby incorporated by reference in their entireties.

### TECHNICAL FIELD

The present invention relates to a polycarbonate-based resin composition and a molded article thereof.

### BACKGROUND ART

A polycarbonate resin is excellent in, for example, transparency, mechanical properties, thermal properties, electrical properties, and weatherability. Through utilization of those characteristics, the polycarbonate resin has been used in various optical molded articles, for example, lighting equipment diffusion covers each made of a resin, such as a lighting cover and a display cover, and a lens. Any such optical molded article is required to have a high transmittance (high total light transmittance), a high color tone (less yellow tinge), high durability (less reduction in performance under a high-humidity and high-temperature environment), and the like as well as thin-wall flame retardancy. As a resin composition that achieves high flame retardancy, there has been reported a branched polycarbonate-based resin composition containing a flame retardant, such as a polytetrafluoroethylene. However, such additive generally influences the transmittance to be reduced and the yellow tinge to be increased, and hence it has been difficult to satisfy the thin-wall flame retardancy simultaneously with a high transmittance and a high color tone.

For example, Patent Document 1 relates to a flame-retardant light-diffusing polycarbonate resin composition containing an aromatic polycarbonate resin, an organometallic salt compound, and a polytetrafluoroethylene. Patent Document 2 relates to a flame-retardant light-diffusing polycarbonate resin composition containing polycarbonates including a branched polycarbonate and an aromatic polycarbonate, a flame retardant, and a polytetrafluoroethylene. In Patent Document 3, there are disclosures of a polycarbonate resin composition that satisfies specific requirements and a polycarbonate resin composition containing a polyether compound as an optional component. Patent Document 4 relates to an aromatic polycarbonate-based resin composition having its light transmittance and luminance improved by incorporating a specific polyoxyalkylene glycol. Patent Document 5 relates to an aromatic polycarbonate resin composition for a light-guiding plate, containing an aromatic polycarbonate resin, and a polyalkylene glycol or a fatty acid ester thereof.

### CITATION LIST

### Patent Document

Patent Document 1: JP 6133644 B2

Patent Document 2: JP 5714576 B2

Patent Document 3: JP 2015-93913 A

Patent Document 4: WO 2011/083635 A1

Patent Document 5: JP 4069364 B2

### SUMMARY OF INVENTION

### Technical Problem

The composition of Patent Document 1 is excellent in flame retardancy, but mainly uses a phenol-based antioxidant as an antioxidant, resulting in a poor color tone. In addition, the color tone is improved by using a fluorescent whitening agent in combination, and hence there is a problem in that the total light transmittance and the durability are reduced. In Patent Document 2, there is a description that a known antioxidant may be used without any particular limitation, which is insufficient for obtaining an excellent color tone. The compositions disclosed in Patent Documents 3 to 5 are insufficient for obtaining flame retardancy, in particular, excellent thin-wall flame retardancy.

In view of the foregoing, an object of the present invention is to provide a polycarbonate-based resin composition excellent in both of color tone and flame retardancy, in particular, thin-wall flame retardancy.

### Solution to Problem

The inventors of the present invention have made extensive investigations, and as a result, have found that a polycarbonate-based resin composition including a branched polycarbonate-based resin and specific compounds in a combination of specific amounts achieves the above-mentioned object. Thus, the inventors have completed the present invention. That is, the present invention provides the following polycarbonate-based resin composition and molded article thereof.
[1] A polycarbonate-based resin composition, comprising:
a polycarbonate-based resin (A) having a branching ratio of 0.01 mol % or more and 3.0 mol % or less; and
a diphosphite compound (B) represented by the following general formula (I),
wherein a content of the diphosphite compound (B) is from 0.005 part by mass to 0.5 part by mass with respect to 100 parts by mass of the polycarbonate-based resin (A):

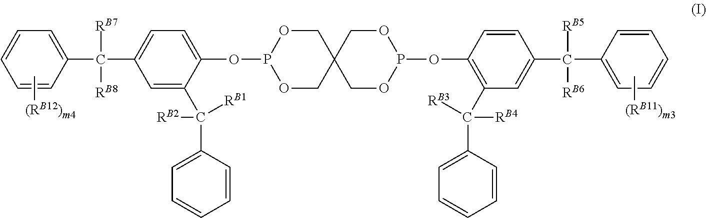

wherein:
R^{B1} to R^{B8} each independently represent an alkyl group or an alkenyl group, and may be identical to or different from each other;
R^{B1} and R^{B2}, R^{B3} and R^{B4}, R^{B5} and R^{B6}, or R^{B7} and R^{B8} may be bonded to each other to form a ring;
R^{B9}, R^{B10}, R^{B11}, and R^{B12} each independently represent a hydrogen atom or an alkyl group, and may be identical to or different from each other;
m1 to m4 each represent an integer of 0 or more and 5 or less, and may be identical to or different from each other; and
when any one of m1 to m4 represents 2 or more, a plurality of R^{B9}, R^{B10}, R^{B11}, or R^{B12} may be identical to or different from each other.
[2] The polycarbonate-based resin composition according to the above-mentioned item [1], wherein the polycarbonate-based resin (A) is formed of 10 mass % to 100 mass % of a branched polycarbonate-based resin (A-1) and 0 mass % to 90 mass % of an aromatic polycarbonate-based resin (A-2) except the (A-1).
[3] The polycarbonate-based resin composition according to the above-mentioned item [1] or [2], wherein the polycarbonate-based resin (A) has a melt viscosity at 280° C. and a shear rate of 10 s⁻¹ of from 3,000 Pa·s to 6,000 Pa·s.
[4] The polycarbonate-based resin composition according to any one of the above-mentioned items [1] to [3], wherein the polycarbonate-based resin (A) has a viscosity-average molecular weight of from 10,000 to 50,000.
[5] The polycarbonate-based resin composition according to any one of the above-mentioned items [1] to [4], further comprising 0.001 part by mass or more and 1 part by mass or less of at least one kind selected from the group consisting of an organic alkali metal salt and an organic alkaline earth metal salt (C) with respect to 100 parts by mass of the polycarbonate-based resin (A).
[6] The polycarbonate-based resin composition according to any one of the above-mentioned items [1] to [5], further comprising 0.02 part by mass or more and 2.0 parts by mass or less of a polyether (D) having a polyoxyalkylene structure with respect to 100 parts by mass of the polycarbonate-based resin (A).
[7] The polycarbonate-based resin composition according to any one of the above-mentioned items [1] to [6], further comprising a polytetrafluoroethylene (E).
[8] The polycarbonate-based resin composition according to the above-mentioned item [7], wherein the polytetrafluoroethylene (E) is an aqueous dispersion-type or acryl-coated polytetrafluoroethylene.
[9] The polycarbonate-based resin composition according to any one of the above-mentioned items [1] to [8], further comprising an alicyclic epoxy compound (F).
[10] The polycarbonate-based resin composition according to the above-mentioned item [9], wherein the alicyclic epoxy compound (F) is 3′,4′-epoxycyclohexylmethyl-3,4-epoxycyclohexanecarboxylate.
[11] The polycarbonate-based resin composition according to any one of the above-mentioned items [1] to [10], further comprising a UV absorber (G).
[12] The polycarbonate-based resin composition according to any one of the above-mentioned items [1] to [11], further comprising a diffuser (H).
[13] The polycarbonate-based resin composition according to any one of the above-mentioned items [1] to [12], wherein the polycarbonate-based resin composition has a flame retardancy of V-0 under a UL94 standard when molded to have a thickness of 1.0 mm.
[14] The polycarbonate-based resin composition according to any one of the above-mentioned items [1] to [6] and [9] to [13], wherein the polycarbonate-based resin composition is free of any polytetrafluoroethylene and has an initial YI value of 1.3 or less when molded to have a thickness of 1.0 mm.
[15] The polycarbonate-based resin composition according to any one of the above-mentioned items [7] to [13],
wherein a content of a polytetrafluoroethylene (E) is 0.10 part by mass or less, and
wherein the polycarbonate-based resin composition has an initial YI value of 3.5 or less when molded to have a thickness of 1.0 mm.
[16] The polycarbonate-based resin composition according to any one of the above-mentioned items [7] to [13],
wherein a content of a polytetrafluoroethylene (E) is 0.15 part by mass or less, and
wherein the polycarbonate-based resin composition has an initial YI value of 4.6 or less when molded to have a thickness of 1.0 mm.
[17] A molded article, comprising the polycarbonate-based resin composition of any one of the above-mentioned items [1] to [16]

### Advantageous Effects of Invention

The molded article formed of the polycarbonate-based resin composition of the present invention has a low YI value and maintains a low YI value even under high temperature and high moist heat, and hence is extremely excellent in color tone. Further, the molded article can be excellent in both of color tone and flame retardancy, in particular, thin-wall flame retardancy. The molded article is suitable as various optical molded articles, for example, lighting equipment diffusion covers each made of a resin, such as a lighting cover and a display cover, and a lens.

### DESCRIPTION OF EMBODIMENTS

A polycarbonate-based resin composition of the present invention includes: a polycarbonate-based resin (A) having a branching ratio of 0.01 mol % or more and 3.0 mol % or less; and a diphosphite compound (B) having a specific structure, wherein a content of the diphosphite compound (B) is from 0.005 part by mass to 0.5 part by mass with respect to 100 parts by mass of the polycarbonate-based resin (A).

The polycarbonate-based resin composition, and a molded article thereof, of the present invention are described in detail below. In this description, a specification considered to be preferred may be arbitrarily adopted, and it can be said that a combination of preferred specifications is more preferred. The term “XX to YY” as used herein means “XX or more and YY or less.”

### Polycarbonate-based Resin (A)

The polycarbonate-based resin composition of the present invention includes the polycarbonate-based resin (A) having a branching ratio of 0.01 mol % or more and 3.0 mol % or less. Specifically, it is preferred that the polycarbonate-based resin (A) be formed of 10 mass % to 100 mass % of a branched polycarbonate-based resin (A-1) and 0 mass % to 90 mass % of an aromatic polycarbonate-based resin (A-2) except the (A-1).

### Branched Polycarbonate-based Resin (A-1)

The branched polycarbonate-based resin (A-1) is not particularly limited as long as the branched polycarbonate-based resin (A-1) is a polycarbonate-based resin having a branched structure. An example thereof may be a polycarbonate-based resin having a repeating unit represented by the following general formula (II) and having a branched structure represented by the following general formula (III):

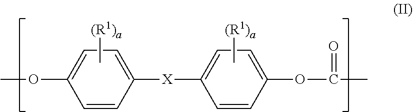

wherein R¹ and R² each independently represent a halogen atom, an alkyl group having 1 to 6 carbon atoms, or an alkoxy group having 1 to 6 carbon atoms, X represents a single bond, an alkylene group having 1 to 8 carbon atoms, an alkylidene group having 2 to 8 carbon atoms, a cycloalkylene group having 5 to 15 carbon atoms, a cycloalkylidene group having 5 to 15 carbon atoms, —S—, —SO—, —SO₂—, —O—, or —CO—, and “a” and “b” each independently represent an integer of from 0 to 4;

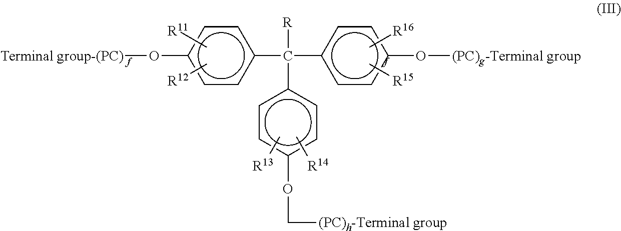

wherein R represents a hydrogen atom or an alkyl group having 1 to 5 carbon atoms, R¹¹ to R¹⁶ each independently represent a hydrogen atom, an alkyl group having 1 to 5 carbon atoms, or a halogen atom, PC represents a polycarbonate moiety, and “f”, “g”, and “h” each represent an integer.

In the general formula (II), examples of the halogen atom that R¹ and R² each independently represent include a fluorine atom, a chlorine atom, a bromine atom, and an iodine atom.

Examples of the alkyl group that R¹ and R² each independently represent include a methyl group, an ethyl group, a n-propyl group, an isopropyl group, various butyl groups (the term “various” means that a linear group and all kinds of branched groups are included, and in this description, the same holds true for the following), various pentyl groups, and various hexyl groups. Examples of the alkoxy group that R¹ and R² each independently represent include alkoxy groups having the above-mentioned alkyl groups as alkyl group moieties.

Examples of the alkylene group represented by X include a methylene group, an ethylene group, a trimethylene group, a tetramethylene group, and a hexamethylene group. Among them, an alkylene group having 1 to 5 carbon atoms is preferred. Examples of the alkylidene group represented by X include an ethylidene group and an isopropylidene group. Examples of the cycloalkylene group represented by X include a cyclopentanediyl group, a cyclohexanediyl group, and a cyclooctanediyl group. Among them, a cycloalkylene group having 5 to 10 carbon atoms is preferred. Examples of the cycloalkylidene group represented by X include a cyclohexylidene group, a 3,5,5-trimethylcyclohexylidene group, and a 2-adamantylidene group. Among them, a cycloalkylidene group having 5 to 10 carbon atoms is preferred, and a cycloalkylidene group having 5 to 8 carbon atoms is more preferred.

“a” and “b” each independently represent an integer of from 0 to 4, preferably from 0 to 2, more preferably 0 or 1. Among them, a repeating unit in which “a” and “b” each represent 0, and X represents a single bond or an alkylene group having 1 to 8 carbon atoms, or a repeating unit in which “a” and “b” each represent 0, and X represents an alkylene group having 3 carbon atoms, in particular, an isopropylidene group is suitable.

The branched structure is described. The polycarbonate moiety represented by PC in the formula (III) has a repeating unit represented by the above-mentioned general formula (II), for example, a repeating unit derived from bisphenol A that is represented by the following formula (IV). A branching agent and a raw material dihydric phenol to be used at the time of the production of the branched polycarbonate-based resin (A-1) are described later.

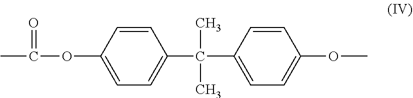

It is preferred that the branched polycarbonate-based resin (A-1) have the branched structure represented by the general formula (III), and have a branching ratio of 0.01 mol % or more and 3.0 mol % or less. When the branching ratio of the branched polycarbonate-based resin (A-1) falls within the range, the flame retardancy of the polycarbonate-based resin composition of the present invention can be further improved, and the polycarbonate is easy to produce because gelation hardly occurs during its polymerization. The branching ratio of the branched polycarbonate-based resin (A-1) means the ratio of the number of moles of a structural unit derived from the branching agent to the total number of moles of a structural unit derived from the dihydric phenol, the structural unit derived from the branching agent being used in the production of the branched polycarbonate-based resin (A-1), and a terminal unit (number of moles of structural unit derived from branching agent/total number of moles of (structural unit derived from dihydric phenol+structural unit derived from branching agent+terminal unit)×100 (represented in the unit of mol %)). The branching ratio may be actually measured by ¹H-NMR measurement.

When the branching agent to be described later is added at 0.01 mol % or more and 3.0 mol % or less with respect to the total number of moles of the dihydric phenol compound, the branching agent, and a terminal stopper, which are raw materials for the branched polycarbonate-based resin (A-1), at the time of the production of the polycarbonate-based resin, a branched polycarbonate-based resin having a branching ratio in the above-mentioned range can be obtained.

From the viewpoint of obtaining more excellent flame retardancy, the branching ratio of the branched polycarbonate-based resin (A-1) is more preferably 0.3 mol % or more, still more preferably 0.4 mol % or more, still further more preferably 0.7 mol % or more, still further more preferably 0.9 mol % or more, still further more preferably 1.0 mol % or more, still further more preferably 1.4 mol % or more, particularly preferably 1.5 mol % or more. From the viewpoint of obtaining more satisfactory physical properties, and the viewpoint of ease of production, the branching ratio of the branched polycarbonate-based resin (A-1) is more preferably 2.8 mol % or less, still more preferably 2.6 mol % or less, still further more preferably 2.3 mol % or less, still further more preferably 2.0 mol % or less. The branched structure may be derived from a single branching agent, or may be derived from two or more of branching agents. The branched structure represented by the general formula (III) more preferably has a branched structure that is a structure derived from 1,1,1-tris(4-hydroxyphenyl)ethane among such branching agents.

The branched polycarbonate-based resin (A-1) has a viscosity-average molecular weight (Mv) of preferably from 10,000 to 50,000, more preferably from 15,000 to 30,000, still more preferably from 17,000 to 28,000. The viscosity-average molecular weight may be adjusted by using, for example, a molecular weight modifier (terminal stopper), or in accordance with a reaction condition. When the viscosity-average molecular weight of the branched polycarbonate-based resin (A-1) falls within the ranges, a polycarbonate-based resin composition excellent in flame retardancy and also excellent in moldability can be obtained.

The viscosity-average molecular weight (Mv) is a value calculated from the following Schnell's equation by measuring the limiting viscosity [η] of a methylene chloride solution at 20° C.

[η]=1.23×10⁻⁵×Mv^{0.83}

### Aromatic Polycarbonate-based Resin (A-2)

The aromatic polycarbonate-based resin (A-2) is an unbranched polycarbonate-based resin except the branched polycarbonate-based resin (A-1), and preferably has a repeating unit represented by the following general formula (V):

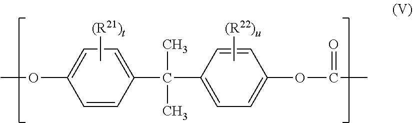

wherein R²¹ and R²² each independently represent a halogen atom, an alkyl group having 1 to 6 carbon atoms, or an alkoxy group having 1 to 6 carbon atoms, X′ represents a single bond, an alkylene group having 1 to 8 carbon atoms, an alkylidene group having 2 to 8 carbon atoms, a cycloalkylene group having 5 to 15 carbon atoms, a cycloalkylidene group having 5 to 15 carbon atoms, —S—, —SO—, —SO₂—, —O—, or —CO—, and “t” and “u” each independently represent an integer of from 0 to 4.

Specific examples of the halogen atom, the alkyl group having 1 to 6 carbon atoms, or the alkoxy group having 1 to 6 carbon atoms represented by each of R²¹ and R²² in the formula (v) are the same as those described above for R¹ and R². Specific examples of the alkylene group having 1 to 8 carbon atoms, the alkylidene group having 2 to 8 carbon atoms, the cycloalkylene group having 5 to 15 carbon atoms, or the cycloalkylidene group having 5 to 15 carbon atoms represented by X′ are the same as those described above for X. “t” and “u” each independently represent an integer of from 0 to 4, preferably from 0 to 2, more preferably 0 or 1.

Among such resins, a resin in which “t” and “u” each represent 0, and X′ represents a single bond or an alkylene group having 1 to 8 carbon atoms, or a resin in which “t” and “u” each represent 0, and X′ represents an alkylidene group, in particular, an isopropylidene group is suitable. The polycarbonate-based resin of the present invention may include a plurality of kinds of polycarbonate blocks as the aromatic polycarbonate-based resins (A-2).

When the polycarbonate-based resin includes the plurality of kinds of polycarbonate blocks as the aromatic polycarbonate-based resins (A-2), the content of a resin in which “a” and “b” each represent 0, and X represents an isopropylidene group is preferably 90 mass % or more, more preferably 90.9 mass % or more, still more preferably 93.3 mass % or more, particularly preferably 95 mass % or more, most preferably 100 mass % from the viewpoints of the transparency and the color tone of the polycarbonate-based resin.

The viscosity-average molecular weight (Mv) of the aromatic polycarbonate resin (A-2) is typically from 10,000 to 50,000, preferably from 13,000 to 35,000, more preferably from 14,000 to 28,000.

The viscosity-average molecular weight (Mv) was calculated from Schnell's equation as with the branched polycarbonate-based resin (A-1).

### Polycarbonate-based Resin (A)

The polycarbonate-based resin (A) in the polycarbonate-based resin composition of the present invention is required to have a branching ratio of 0.01 mol % or more and 3.0 mol % or less.

The polycarbonate-based resin (A) contains the branched polycarbonate-based resin (A-1). The branching ratio of the polycarbonate-based resin (A) means the ratio of the number of moles of a structural unit derived from the branching agent to the total number of moles of a structural unit derived from the dihydric phenol, the structural unit derived from the branching agent being used in the production of the branched polycarbonate-based resin (A-1) and the aromatic polycarbonate-based resin (A-2) except the resin (A-1), and a terminal unit (number of moles of structural unit derived from branching agent/total number of moles of (structural unit derived from dihydric phenol+structural unit derived from branching agent+terminal unit)×100 (represented in the unit of mol %)). The branching ratio may be actually measured by ¹H-NMR measurement.

In addition, the polycarbonate-based resin (A) preferably has a melt viscosity at 280° C. and a shear rate of 10 s⁻¹ of from 3,000 Pa·s to 6,000 Pa·s because excellent flame retardancy is obtained. However, when the polycarbonate-based resin has such high melt viscosity, the temperature of the resin is increased owing to shear heating, and hence there is a problem in that the resin is liable to be thermally altered during kneading or the like to undergo yellowing. In the present invention, it has been found that, even in the case where the polycarbonate-based resin (A) has a high branching ratio and a high melt viscosity at 280° C. and a shear rate of 10 s⁻¹ of from 3,000 Pa·s to 6,000 Pa·s, when the diphosphite compound (B) to be described later is incorporated in a specific amount, the yellowing of a molded article due to shear heating can be suppressed and excellent flame retardancy can be achieved as well. A method of measuring the melt viscosity, which is specifically described in Examples, is as follows: the polycarbonate-based resin (A) was dried at 120° C. for 4 hours or more, followed by measurement with a capillary rheometer at a measurement temperature of 280° C. and a shear rate ranging from 1 s⁻¹ to 100 s⁻¹ in conformity with JIS K 7199:1999. The melt viscosity of the polycarbonate resin composition at a shear rate of 10 s⁻¹ was determined from the measurement results thus obtained.

The melt viscosity of the polycarbonate-based resin (A) at 280° C. and a shear rate of 10 s⁻¹ is more preferably 3,100 Pa·s or more, still more preferably 3,500 Pa·s or more, still further more preferably 4,000 Pa·s or more, and is more preferably 5,500 Pa·s or less, still more preferably 5,000 Pa·s or less, still further more preferably 4,800 Pa·s or less.

The polycarbonate-based resin (A) in the polycarbonate-based resin composition of the present invention is formed of the branched polycarbonate-based resin (A-1) and the aromatic polycarbonate-based resin (A-2) except the resin (A-1), and the content of the branched polycarbonate-based resin (A-1) is preferably from 10 mass % to 100 mass % from the viewpoint of obtaining high flame retardancy. The content of the branched polycarbonate-based resin (A-1) is more preferably 55 mass % or more, still more preferably 60 mass % or more, still further more preferably 65 mass % or more, particularly preferably 70 mass % or more, and may be 100 mass %. The content of the aromatic polycarbonate-based resin (A-2) is the balance excluding the branched polycarbonate-based resin (A-1).

A branching ratio in the polycarbonate-based resin (A) of the present invention is 0.01 mol % or more and 3.0 mol % or less. The branching ratio is preferably 0.3 mol % or more, more preferably 0.5 mol % or more, still more preferably 0.7 mol % or more, still further more preferably 1.0 mol % or more, still further more preferably 1.4 mol % or more, particularly preferably 1.5 mol % or more, and is preferably 2.8 mol % or less, more preferably 2.6 mol % or less, still more preferably 2.3 mol % or less, still further more preferably 2.0 mol % or less. When the branching ratio in the polycarbonate-based resin (A) falls within the ranges, a polycarbonate-based resin composition excellent in flame retardancy, specifically excellent in thin-wall flame retardancy is obtained.

The viscosity-average molecular weight of the polycarbonate-based resin (A) is preferably from 10,000 to 50,000, more preferably from 13,000 to 35,000, still more preferably from 15,000 to 30,000, still further more preferably from 17,000 to 28,000, still further more preferably from 22,000 to 26,000. When the viscosity-average molecular weight of the polycarbonate-based resin (A) falls within the ranges, excellent flame retardancy and excellent moldability can be obtained. The viscosity-average molecular weight was calculated from Schnell's equation as with the branched polycarbonate-based resin (A-1).

### Method of producing Polycarbonate-based Resin (A)

The branched polycarbonate-based resin (A-1) and the aromatic polycarbonate-based resin (A-2), which form the polycarbonate-based resin (A), may each be produced through a step (1) of causing a dihydric phenol and phosgene to react with each other in an organic solvent to produce a polycarbonate oligomer, and a subsequent step (2) of causing the polycarbonate oligomer, a dihydric phenol, and a terminal stopper to react with each other to produce the polycarbonate-based resin.

### Step (1)

In this step, the dihydric phenol and phosgene are caused to react with each other in the organic solvent to produce the polycarbonate oligomer having a chloroformate group.

It is preferred to use, as the dihydric phenol, a compound represented by the following general formula (i) in the case of the branched polycarbonate-based resin (A-1), or a compound represented by the following general formula (ii) in the case of the aromatic polycarbonate-based resin (A-2):

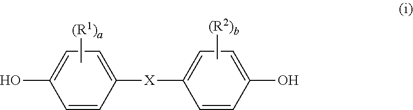

wherein R¹, R², “a”, “b”, and X are as described above;

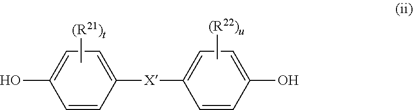

wherein R²¹, R²², “t”, “u”, and X′ are as described above.

Examples of the dihydric phenol represented by each of the general formulae (i) and (ii) include: bis(hydroxyphenyl)alkane-based dihydric phenols, such as 2,2-bis(4-hydroxyphenyl)propane [bisphenol A], bis(4-hydroxyphenyl)methane, 1,1-bis(4-hydroxyphenyl)ethane, and 2,2-bis(4-hydroxy-3,5-dimethylphenyl)propane; 4,4′-dihydroxydiphenyl; bis(4-hydroxyphenyl)cycloalkanes; bis(4-hydroxyphenyl) oxide; bis(4-hydroxyphenyl) sulfide; bis(4-hydroxyphenyl) sulfone; bis(4-hydroxyphenyl) sulfoxide; and bis(4-hydroxyphenyl) ketone. Those dihydric phenols may be used alone or in combination thereof.

Among them, bis(hydroxyphenyl)alkane-based dihydric phenols are preferred, and bisphenol A is more preferred. When bisphenol A is used as the dihydric phenol, there is obtained a branched polycarbonate-based resin (A-1) in which, in the general formula (II), X represents an isopropylidene group and a=b=0, or an aromatic polycarbonate-based resin (A-2) in which, in the general formula (V), X′ represents an isopropylidene group and t=u=0.

Examples of the dihydric phenol except bisphenol A include bis(hydroxyaryl)alkanes, bis(hydroxyaryl)cycloalkanes, dihydroxyaryl ethers, dihydroxydiaryl sulfides, dihydroxydiaryl sulfoxides, dihydroxydiaryl sulfones, dihydroxydiphenyls, dihydroxydiaryl fluorenes, and dihydroxydiaryl adamantanes. Those dihydric phenols may be used alone or as a mixture thereof.

Examples of the bis(hydroxyaryl)alkanes include bis(4-hydroxyphenyl)methane, 1,1-bis(4-hydroxyphenyl)ethane, 2,2-bis(4-hydroxyphenyl)butane, 2,2-bis(4-hydroxyphenyl)octane, bis(4-hydroxyphenyl)phenylmethane, bis(4-hydroxyphenyl)diphenylmethane, 2,2-bis(4-hydroxy-3-methylphenyl)propane, bis(4-hydroxyphenyl)naphthylmethane, 1,1-bis(4-hydroxy-3-tert-butylphenyl)propane, 2,2-bis(4-hydroxy-3-bromophenyl)propane, 2,2-bis(4-hydroxy-3,5-dimethylphenyl)propane, 2,2-bis(4-hydroxy-3-chlorophenyl)propane, 2,2-bis(4-hydroxy-3,5-dichlorophenyl)propane, and 2,2-bis(4-hydroxy-3,5-dibromophenyl)propane.

Examples of the bis(hydroxyaryl)cycloalkanes include 1,1-bis(4-hydroxyphenyl)cyclopentane, 1,1-bis(4-hydroxyphenyl)cyclohexane, 1,1-bis(4-hydroxyphenyl)-3,5,5-trimethylcyclohexane, 2,2-bis(4-hydroxyphenyl)norbornane, and 1,1-bis(4-hydroxyphenyl)cyclododecane. Examples of the dihydroxyaryl ethers include 4,4′-dihydroxydiphenyl ether and 4,4′-dihydroxy-3,3′-dimethylphenyl ether.

Examples of the dihydroxydiaryl sulfides include 4,4′-dihydroxydiphenyl sulfide and 4,4′-dihydroxy-3,3′-dimethyldiphenyl sulfide. Examples of the dihydroxydiaryl sulfoxides include 4,4′-dihydroxydiphenyl sulfoxide and 4,4′-dihydroxy-3,3′-dimethyldiphenyl sulfoxide. Examples of the dihydroxydiaryl sulfones include 4,4′-dihydroxydiphenyl sulfone and 4,4′-dihydroxy-3,3′-dimethyldiphenyl sulfone.

An example of the dihydroxydiphenyls is 4,4′-dihydroxydiphenyl. Examples of the dihydroxydiarylfluorenes include 9,9-bis(4-hydroxyphenyl)fluorene and 9,9-bis(4-hydroxy-3-methylphenyl)fluorene. Examples of the dihydroxydiaryladamantanes include 1,3-bis(4-hydroxyphenyl)adamantane, 2,2-bis(4-hydroxyphenyl)adamantane, and 1,3-bis(4-hydroxyphenyl)-5,7-dimethyladamantane.

Examples of dihydric phenols except those described above include 4,4′-[1,3-phenylenebis(1-methylethylidene)]bisphenol, 10,10-bis(4-hydroxyphenyl)-9-anthrone, and 1,5-bis(4-hydroxyphenylthio)-2,3-dioxapentane.

Phosgene is a compound that is typically obtained by causing chlorine and carbon monoxide to react with each other at the following ratio through use of activated carbon as a catalyst: 1.01 mol to 1.3 mol of carbon monoxide is used with respect to 1 mol of chlorine. When phosgene to be used is used as a phosgene gas, a phosgene gas containing about 1 vol % to about 30 vol % of unreacted carbon monoxide may be used. Phosgene in a liquefied state may also be used.

To produce the polycarbonate oligomer in the step (1), an aqueous alkali solution of the dihydric phenol, phosgene, and the organic solvent are introduced into a reactor, and the dihydric phenol and phosgene are caused to react with each other. The usage amount of the organic solvent is desirably selected so that a volume ratio between an organic solvent phase and an aqueous phase may be from 5/1 to 1/7, preferably from 2/1 to 1/4. In the reactor, heat is generated by a reaction in which a terminal group of the dihydric phenol is turned into a chloroformate by phosgene, and a reaction in which phosgene is decomposed by an alkali, and hence the temperature of a reaction product increases. Therefore, the reaction product is preferably cooled so that its temperature may be from 0° C. to 50° C., more preferably from 5° C. to 40° C. Phosgene is preferably used so that the usage amount of phosgene may be from 1.1 mol to 1.5 mol with respect to 1 mol of the dihydric phenol, that is, may be excess. A reaction liquid obtained after the reaction is separated into an aqueous phase and an organic phase. Thus, the organic phase containing the polycarbonate oligomer is obtained. The weight-average molecular weight of the resultant polycarbonate oligomer is typically 5,000 or less, and the degree of polymerization thereof is typically 20 or less, preferably from 2 to 10.

At the time of the production of the polycarbonate oligomer, the amine-based polymerization catalyst to be used in the subsequent step (2) may be used for accelerating the reaction. A terminal stopper to be used as a molecular weight modifier for a polycarbonate may be used. Examples of a compound to be used as the terminal terminator may include monohydric phenols, such as phenol, p-cresol, p-tert-butylphenol, p-tert-octylphenol, p-cumylphenol, 3-pentadecylphenol, bromophenol, tribromophenol, and nonylphenol. Among them, p-tert-butylphenol, p-cumylphenol, and phenol are preferred in terms of, for example, economical efficiency and ease of availability. In addition, the use of 3-pentadecylphenol can largely improve the fluidity of the polycarbonate oligomer to be obtained.

The reactor to be used at the time of the production of the polycarbonate oligomer is preferably a stationary mixer, that is, a static mixer. The stationary mixer is preferably a tubular reactor including, in itself, an element having an action of dividing, turning, and reversing a fluid. When a vessel-type stirring vessel including a stirring machine is further used after the stationary mixer, oligomerization can be accelerated. Accordingly, such reactors are preferably used in combination.

A reaction mixed liquid containing the polycarbonate oligomer having a chloroformate group is obtained through the step (1). The reaction mixed liquid is separated into an organic phase containing the polycarbonate oligomer and an aqueous phase by using a separation method, such as settling, and the organic phase containing polycarbonate oligomer is used in the step (2) to be described later.

### Step (2)

In the step (2), the polycarbonate oligomer obtained in the step (1), the dihydric phenol, and the terminal stopper are caused to react with each other to produce the polycarbonate-based resin. The polycarbonate oligomer and the dihydric phenol are subjected to a polycondensation reaction so that the molecular weight of a reaction product may be adjusted within a target molecular weight range. The polycondensation reaction is performed until the viscosity-average molecular weight of the polycarbonate-based resin to be obtained falls within the above-mentioned range.

Specifically, the organic solvent phase containing the polycarbonate oligomer that has been separated in the step (1), the terminal stopper to be used if desired, the polymerization catalyst to be used if desired, an organic solvent, an aqueous alkali solution, and an aqueous alkali solution of the dihydric phenol are mixed, and the mixture is subjected to interfacial polycondensation at a temperature in the range of typically from 0° C. to 50° C., preferably from 20° C. to 40° C.

Examples of the alkali of each of the aqueous alkali solutions, the organic solvent, and the terminal stopper to be used in this step may include the same examples as those described for the step (1). The usage amount of the organic solvent in the step (2) is typically selected so that a volume ratio between the organic phase and aqueous phase of a reaction liquid to be obtained may be preferably from 7/1 to 1/1, more preferably from 5/1 to 2/1.

With regard to a reactor to be used in the step (2), the reaction can be completed with only one reactor depending on the processing capacity of the reactor. However, a plurality of reactors such as a second reactor and a third reactor subsequent to the first reactor may be used as required. For example, a stirring vessel, a multistage column-type stirring vessel, a non-stirring vessel, a static mixer, a line mixer, an orifice mixer, and/or piping may be used as any such reactor.

The resultant reaction liquid is subjected to oil-water separation because the reaction liquid includes the organic solvent phase containing the polycarbonate-based resin and the aqueous phase containing an unreacted dihydric phenol. An apparatus for the separation may be, for example, a settling vessel or a centrifugal separator. The separated organic solvent phase containing the polycarbonate-based resin is subjected to alkali washing, acid washing, and pure water washing in the stated order to provide an organic solvent phase containing the purified polycarbonate-based resin. The organic solvent phase containing the purified polycarbonate-based resin is concentrated as required, and is then subjected to a kneader treatment, warm water granulation, or the like. Thus, the powder of the polycarbonate-based resin can be obtained. The organic solvent remains in the resultant powder of the polycarbonate-based resin, and hence the performance of a drying treatment, such as a heating treatment, can provide polycarbonate-based resin powder from which the organic solvent has been removed. The resultant polycarbonate-based resin powder may be pelletized with a pelletizer or the like to provide various molded articles.

### Branching Agent

The branched polycarbonate-based resin (A-1) can be produced by adding an arbitrary branching agent. The aromatic polycarbonate-based resin (A-2) can be produced by adding no branching agent. The branching agent may be added in the step (1) and/or the step (2). When the branching agent is added in the step (1), the branching agent is added together with the dihydric phenol and phosgene, and the materials are caused to react with each other. A branching agent represented by the general formula (iii) to be described later can be dissolved in an aqueous alkali solution, and is hence desirably introduced after having been dissolved in the aqueous alkali solution, though whether or not the dissolution should be performed varies depending on the branching agent to be used. In addition, a branching agent that is hardly dissolved in an aqueous alkali solution is desirably introduced after having been dissolved in an organic solvent, such as methylene chloride.

The branching agent may be added in any one of the step (1) and the step (2), or in both of the steps (1) and (2). The branching agent may be further added in the step (2). It is preferred that the branching agent be finally added in an addition amount of 0.01 mol % or more and 3.0 mol % or less with respect to the total number of moles of the dihydric phenol compound, the branching agent, and the terminal stopper that are raw materials in terms of total amount of the branching agent to be added in the step (1) and the step (2). The adoption of the addition amount can provide the branched polycarbonate-based resin (A-1) having the above-mentioned preferred branching ratio. The addition amount of the branching agent with respect to the total number of moles of the dihydric phenol compound, the branching agent, and the terminal stopper is more preferably 0.3 mol % or more, still more preferably 0.4 mol % or more, still further more preferably 0.7 mol % or more, still further more preferably 0.9 mol % or more, still further more preferably 1.0 mol % or more, still further more preferably 1.4 mol % or more, particularly preferably 1.5 mol % or more from the viewpoint of obtaining more excellent flame retardancy, and is more preferably 2.8 mol % or less, still more preferably 2.6 mol % or less, still further more preferably 2.3 mol % or less, still further more preferably 2.0 mol % or less from the viewpoint of obtaining more satisfactory physical properties and the viewpoint of ease of production. The setting of the addition amount of the branching agent within the ranges can provide more excellent flame retardancy.

Specifically, a branching agent represented by the following general formula (iii) is used at the time of the production of the branched polycarbonate-based resin represented by the general formula (III):

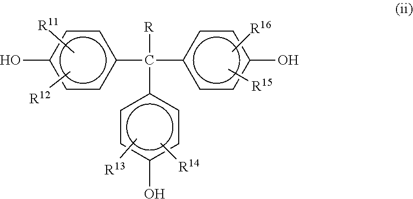

wherein R represents a hydrogen atom or an alkyl group having 1 to 5 carbon atoms, and R¹¹ to R¹⁶ each independently represent a hydrogen atom, an alkyl group having 1 to 5 carbon atoms, or a halogen atom.

The branching agent represented by the general formula (iii) is described in more detail.

Examples of the alkyl group having 1 to 5 carbon atoms that is represented by R include a methyl group, an ethyl group, a n-propyl group, a n-butyl group, and a n-pentyl group. Examples of the alkyl group having 1 to 5 carbon atoms that is represented by any one of R¹¹ to R¹⁶ may include a methyl group, an ethyl group, a n-propyl group, a n-butyl group, and a n-pentyl group, and examples of the halogen atom may include a chlorine atom, a bromine atom, and a fluorine atom.

More specific examples of the branching agent represented by the general formula (iii) include compounds each having 3 or more functional groups, such as: 1,1,1-tris(4-hydroxyphenyl)methane; 1,1,1-tris(4-hydroxyphenyl)ethane; 1,1,1-tris(4-hydroxyphenyl)propane; 1,1,1-tris(2-methyl-4-hydroxyphenyl)methane; 1,1,1-tris(2-methyl-4-hydroxyphenyl)ethane; 1,1,1-tris(3-methyl-4-hydroxyphenyl)methane; 1,1,1-tris(3-methyl-4-hydroxyphenyl)ethane; 1,1,1-tris(3,5-dimethyl-4-hydroxyphenyl)methane; 1,1,1-tris(3,5-dimethyl-4-hydroxyphenyl)ethane; 1,1,1-tris(3-chloro-4-hydroxyphenyl)methane; 1,1,1-tris(3-chloro-4-hydroxyphenyl)ethane; 1,1,1-tris(3,5-dichloro-4-hydroxyphenyl)methane; 1,1,1-tris(3,5-dichloro-4-hydroxyphenyl)ethane; 1,1,1-tris(3-bromo-4-hydroxyphenyl)methane; 1,1,1-tris(3-bromo-4-hydroxyphenyl)ethane; 1,1,1-tris(3,5-dibromo-4-hydroxyphenyl)methane; 1,1,1-tris(3,5-dibromo-4-hydroxyphenyl)ethane; 4,4′-[1-[4-[1-(4-hydroxyphenyl)-1-methylethyl]phenyl]ethylidene]bisphenol; α,α′,α″-tris(4-hydroxyphenyl)-1,3,5-triisopropylbenzene; 1-[α-methyl-α-(4′-hydroxyphenyl)ethyl]-4-[α′,α′-bis(4″-hydroxyphenyl)ethyl]benzene; and phloroglucin, trimellitic acid, and isatinbis(o-cresol). Among those described above, 1,1,1-tris(4-hydroxyphenyl)ethane (hereinafter sometimes abbreviated as “THPE”) is preferably used from the viewpoints of availability, reactivity, and economical efficiency.

### Polymerization Catalyst

The polymerization catalyst may be used in any of the step (1) and the step (2), and, for example, the amine-based catalyst may be used.

As the amine-based catalyst, a tertiary amine or a salt thereof, or a quaternary ammonium salt may be used. Examples of the tertiary amine include triethylamine, tributylamine, N,N-dimethylcyclohexylamine, pyridine, and dimethylaniline, and examples of the tertiary amine salt include hydrochloric acid salts and bromic acid salts of those tertiary amines. Examples of the quaternary ammonium salt may include trimethylbenzylammonium chloride, triethylbenzylammonium chloride, tributylbenzylammonium chloride, trioctylmethylammonium chloride, tetrabutylammonium chloride, and tetrabutylammonium bromide. As the amine-based catalyst, a tertiary amine is preferred, and triethylamine is particularly suitable. Each of those catalysts may be introduced as it when the catalyst is in a liquid state is or after having been dissolved in an organic solvent or water. In addition, a catalyst in a solid state may be introduced after having been dissolved in an organic solvent or water.

When the polymerization catalyst is used in the step (2), the catalyst is used at a molar ratio of typically 0.0005 or more and 0.030 or less with respect to a chloroformate group of the polycarbonate oligomer obtained in the step (1). When the amount of the polymerization catalyst to be added in the step (2) falls within the range, the flame retardancy of the polycarbonate-based resin to be obtained can be improved.

The amount of the polymerization catalyst to be added in the step (2) is more preferably 0.001 or more, still more preferably 0.002 or more, still more preferably 0.004 or more, still more preferably 0.006 or more in terms of molar ratio with respect to a chloroform ate group of the polycarbonate oligomer, and is more preferably 0.025 or less, still more preferably 0.020 or less.

### Diphosphite Compound (B)

The polycarbonate-based resin composition of the present invention includes the diphosphite compound (B) represented by the following general formula (I), and the content of the diphosphite compound is from 0.005 part by mass to 0.5 part by mass with respect to 100 parts by mass of the polycarbonate-based resin (A). The diphosphite compounds (B) may be used alone or in combination thereof.

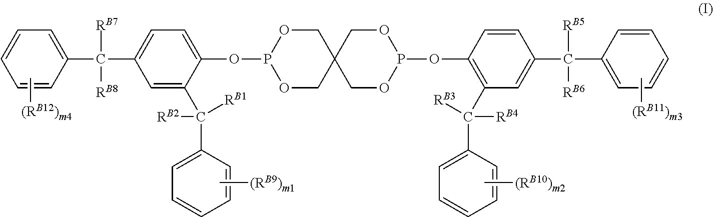

wherein R^{B1} to R^{B8} each independently represent an alkyl group or an alkenyl group, and may be identical to or different from each other; R^{B1} and R^{B2}, R^{B3} and R^{B4}, R^{B5} and R^{B6}, or R^{B7} and R^{B8} may be bonded to each other to form a ring; R^{B9}, R^{B10}, R^{B11}, and R^{B12} each independently represent a hydrogen atom or an alkyl group, and may be identical to or different from each other; m1 to m4 each represent an integer of 0 or more and 5 or less, and may be identical to or different from each other; and when any one of m1 to m4 represents 2 or more, a plurality of R^{B9}, R¹⁰, R^{B11}, or R^{B12} may be identical to or different from each other.

In the general formula (I), R^{B1} to R^{B8} each represent preferably an alkyl group having 1 or more and 5 or less carbon atoms or an alkenyl group having 2 or more and 5 or less carbon atoms, more preferably an alkyl group having 1 or more and 3 or less carbon atoms, still more preferably a methyl group. It is still further more preferred that all of R^{B1} to R^{B8} represent methyl groups.

R^{B9} to R^{B12} each represent preferably a hydrogen atom or an alkyl group having 1 or more and 5 or less carbon atoms, more preferably a hydrogen atom or an alkyl group having 1 or more and 3 or less carbon atoms, still more preferably a hydrogen atom, and it is still further more preferred that all of R^{B9} to R^{B12} represent hydrogen atoms.

m1 to m4 each represent preferably 0 or more and 3 or less, more preferably 0 or more and 1 or less, still more preferably 0.

Among the diphosphite compounds each represented by the general formula (I), bis(2,4-dicumylphenyl)pentaerythritol diphosphite represented by the following formula (I-1) is particularly suitable because this compound can impart long-term moist heat resistance and long-term heat resistance to the polycarbonate-based resin composition and is easily available. This compound is available as a commercial product, and for example, “Doverphos S-9228PC” manufactured by Dover Chemical may be used.

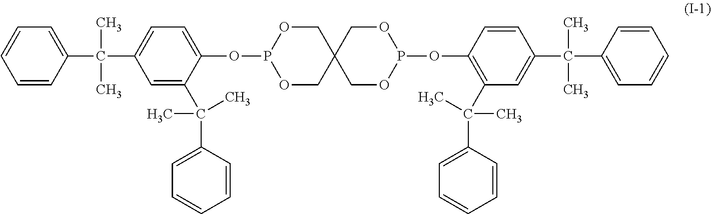 [SMILES: CC(C)(c1ccccc1)c1ccc(OP2OCC3(CO2)COP(Oc2ccc(C(C)(C)c4ccccc4)cc2C(C)(C)c2ccccc2)OC3)c(C(C)(C)c2ccccc2)c1]

In the polycarbonate-based resin composition of the present invention, the content of the diphosphite compound (B) is from 0.005 part by mass to 0.5 part by mass with respect to 100 parts by mass of the polycarbonate-based resin (A). When the content of the diphosphite compound (B) is less than 0.005 part by mass, a suppressing effect on a reduction in color tone due to thermal degradation at the time of the melt-kneading of the resin composition or during the molding of a molded article is insufficient. In addition, a case in which the content of the diphosphite compound (B) is more than 0.5 part by mass is not preferred because durability, such as moist heat resistance, tends to be reduced. The content of the diphosphite compound (B) in the polycarbonate-based resin composition of the present invention is preferably 0.01 part by mass or more, more preferably 0.03 part by mass or more, still more preferably 0.05 part by mass or more with respect to 100 parts by mass of the polycarbonate-based resin, and is preferably 0.40 part by mass or less, more preferably 0.30 part by mass or less, still more preferably 0.25 part by mass or less, still further more preferably 0.20 part by mass or less with respect thereto.

### Other Additives

The polycarbonate resin composition of the present invention may include various additives in addition to the above-mentioned components (A) and (B) to such an extent that its color tone and flame retardancy are not adversely influenced. Examples of those additives may include an organic alkali metal salt and an organic alkaline earth metal salt, a polyether, a polytetrafluoroethylene, an alicyclic epoxy compound, a UV absorber, and a diffuser.

### Organic Alkali Metal Salt and Organic Alkaline Earth Metal Salt (C)

The polycarbonate-based resin composition of the present invention may include at least one kind selected from the group consisting of an organic alkali metal salt and an organic alkaline earth metal salt (hereinafter sometimes collectively referred to as “alkali(ne earth) metal”) (C). Those salts may be used alone or in combination thereof.

An example of the organic alkali(ne earth) metal salt may be an organic sulfonic acid salt of an alkali(ne earth) metal. Examples of the organic sulfonic acid salt of an alkali(ne earth) metal include: a metal salt of a fluorine-substituted alkylsulfonic acid, such as a metal salt of a perfluoroalkylsulfonic acid and an alkali metal or an alkaline earth metal; and a metal salt of an aromatic sulfonic acid and an alkali metal or an alkaline earth metal.

Examples of the alkali metal include lithium, sodium, potassium, rubidium, and cesium. Examples of the alkaline earth metal include beryllium, magnesium, calcium, strontium, and barium. Among them, an alkali metal is more preferred.

Among those alkali metals, potassium and sodium are preferred, and potassium is particularly preferred from the viewpoints of flame retardancy and thermal stability. A potassium salt and a sulfonic acid alkali metal salt formed of another alkali metal may be used in combination.

Specific examples of the perfluoroalkylsulfonic acid alkali metal salt include potassium trifluoromethanesulfonate, potassium nonafluorobutanesulfonate, potassium perfluorohexanesulfonate, potassium perfluorooctanesulfonate, sodium pentafluoroethanesulfonate, sodium perfluorobutanesulfonate, sodium perfluorooctanesulfonate, lithium trifluoromethanesulfonate, lithium perfluorobutanesulfonate, lithium perfluoroheptanesulfonate, cesium trifluoromethanesulfonate, cesium perfluorobutanesulfonate, cesium perfluorooctanesulfonate, cesium perfluorohexanesulfonate, rubidium perfluorobutanesulfonate, and rubidium perfluorohexanesulfonate. The perfluoroalkylsulfonic acid alkali metal salts may be used alone or in combination thereof.

The number of carbon atoms of the perfluoroalkyl group is preferably from 1 to 18, more preferably from 1 to 10, still more preferably from 1 to 8. Among them, potassium nonafluorobutanesulfonate is particularly preferred.

Specific examples of the sulfonic acid alkali(ne earth) metal salt include disodium diphenyl sulfide-4,4′-disulfonate, dipotassium diphenyl sulfide-4,4′-disulfonate, potassium 5-sulfoisophthalate, sodium 5-sulfoisophthalate, polysodium polyethylene terephthalate polysulfonate, calcium 1-methoxynaphthalene-4-sulfonate, disodium 4-dodecyl phenyl ether disulfonate, polysodium poly(2,6-dimethylphenylene oxide) polysulfonate, polysodium poly(1,3-phenylene oxide) polysulfonate, polysodium poly(1,4-phenylene oxide) polysulfonate, polypotassium poly(2,6-diphenylphenylene oxide) polysulfonate, lithium poly(2-fluoro-6-butylphenylene oxide) polysulfonate, potassium benzenesulfonate, sodium benzenesulfonate, sodium p-toluenesulfonate, strontium benzenesulfonate, magnesium benzenesulfonate, dipotassium p-benzenedisulfonate, dipotassium naphthalene-2,6-disulfonate, calcium biphenyl-3,3′-disulfonate, sodium diphenyl sulfone-3-sulfonate, potassium diphenyl sulfone-3-sulfonate, dipotassium diphenyl sulfone-3,3′-disulfonate, dipotassium diphenyl sulfone-3,4′-disulfonate, sodium α,α,α-trifluoroacetophenone-4-sulfonate, dipotassium benzophenone-3,3′-disulfonate, disodium thiophene-2,5-disulfonate, dipotassium thiophene-2,5-disulfonate, calcium thiophene-2,5-disulfonate, sodium benzothiophenesulfonate, potassium diphenyl sulfoxide-4-sulfonate, a formalin condensate of sodium naphthalenesulfonate, and a formalin condensate of sodium anthracenesulfonate. Among those sulfonic acid alkali(ne earth) metal salts, a sodium salt and a potassium salt are particularly suitable.

It is desired that the polycarbonate-based resin composition of the present invention include the organic alkali(ne earth) metal salt at typically from 0.001 part by mass to 1 part by mass, preferably from 0.01 part by mass to 0.1 part by mass, more preferably from 0.02 part by mass to 0.08 part by mass with respect to 100 parts by mass of the polycarbonate-based resin (A). When the content of the organic alkali(ne earth) metal salt is 0.001 part by mass or more, sufficient flame retardancy is obtained, and when the content is 1 part by mass or less, the contamination of a mold can be suppressed. The above-mentioned organic alkali(ne earth) metal salts may be used alone or in combination thereof. When the composition includes a plurality of kinds of organic alkali(ne earth) metal salts, their total amount falls within the ranges.

### Polyether (D) Having Polyoxyalkylene Structure

The polycarbonate-based resin composition of the present invention may include the polyether (D) having a polyoxyalkylene structure. The polyether (D) having a polyoxyalkylene structure preferably has a polyoxyalkylene structure represented by (R^{D1}O)ₚ and a polyoxyalkylene structure represented by (R^{D2}O)_{q}. In the formulae, R^{D1} and R^{D2} each independently represent an alkylene group having 1 or more carbon atoms. p+q is 5 or more and less than 300, preferably from 10 to 200, more preferably from 20 to 100.

Examples of the alkylene group represented by each of R^{D1} and R^{D2} include a methylene group, an ethylene group, a trimethylene group, a propylene group, a tetramethylene group, and a hexamethylene group. Among them, an alkylene group having 1 to 5 carbon atoms is preferred.

In the “p” R^{D1}O groups, the plurality of R^{D1} may represent alkylene groups identical to each other, or may represent alkylene groups different from each other in number of carbon atoms. That is, the polyoxyalkylene group represented by (R^{D1}O)ₚ is not limited to a group having a single oxyalkylene unit as a repeating unit, such as a polyoxyethylene group or a polyoxypropylene group, and may be a group having as repeating units a plurality of oxyalkylene units different from each other in number of carbon atoms, such as an oxyethylene unit and an oxypropylene unit.

R^{D2} is similar to R^{D1}, and in the “q” R^{D2}O groups, the plurality of R^{D2} may represent alkylene groups identical to each other, or may represent alkylene groups different from each other in number of carbon atoms.

Among the alkylene groups represented by R^{D1} and R^{D2} described above, in particular, it is preferred from the viewpoint of improving an initial color tone that R^{D1} and R^{D2} each represent an alkylene group selected from an ethylene group, a propylene group, and a tetramethylene group, and that at least one of R^{D1} or R^{D2} represent any one of an ethylene group or a propylene group.

The polyether (D) is preferably at least one kind selected from the group consisting of: a compound (D-1) represented by the following general formula (VI); an alkylene oxide adduct of a polyhydric alcohol and an ester thereof (D-2); and a cyclic polyether compound (D-3):

R^{D3}O−(R^{D1}O)ₚ−A−(R^{D2}O)_{q}−R^{D4} (VI)

wherein R^{D1} and R^{D2} each independently represent an alkylene group having 1 or more carbon atoms, p+q is 5 or more and less than 300, R^{D3} and R^{D4} each independently represent a hydrogen atom, a hydrocarbon group having 1 to 30 carbon atoms, an alkanoyl group having 1 to 30 carbon atoms, an alkenoyl group having 2 to 30 carbon atoms, or a glycidyl group, and A represents a single bond or a divalent organic group.

The alkylene group represented by each of R^{D1} and R^{D2} is as described above. The polyoxyalkylene structure represented by (R^{D1}O)ₚ and the polyoxyalkylene structure represented by (R^{D2}O)_{q} are also as described above.

Examples of the hydrocarbon group having 1 to 30 carbon atoms represented by each of R^{D3} and R^{D4} include an alkyl group having 1 to 30 carbon atoms, an alkenyl group having 2 to 30 carbon atoms, an aryl group having 6 to 30 carbon atoms, and an aralkyl group having 7 to 30 carbon atoms.

The alkyl group and the alkenyl group may be linear, branched, or cyclic, and examples thereof include a methyl group, an ethyl group, a n-propyl group, an isopropyl group, various butyl groups, various pentyl groups, various hexyl groups, various octyl groups, a cyclopentyl group, a cyclohexyl group, an allyl group, a propenyl group, various butenyl groups, various hexenyl groups, various octenyl groups, a cyclopentenyl group, and a cyclohexenyl group. Examples of the aryl group include a phenyl group, a tolyl group, and a xylyl group. Examples of the aralkyl group include a benzyl group, a phenethyl group, and a methyl benzyl group.

The alkanoyl group having 1 to 30 carbon atoms that is represented by each of R^{D3} and R^{D4} may be linear or branched, and examples thereof include a methanoyl group, an ethanoyl group, a n-propanoyl group, an isopropanoyl group, a n-butanoyl group, a tert-butanoyl group, a n-hexanoyl group, a n-octanoyl group, a n-decanoyl group, a n-dodecanoyl group, and a benzoyl group. Among them, an alkanoyl group having 1 to 20 carbon atoms is preferred from the viewpoints of compatibility, thermal stability, and ease of production.

The alkenoyl group having 2 to 30 carbon atoms that is represented by each of R^{D3} and R^{D4} may be linear or branched, and examples thereof include an ethenoyl group, a n-propenoyl group, an isopropenoyl group, a n-butenoyl group, a tert-butenoyl group, a n-hexenoyl group, a n-octenoyl group, a n-decenoyl group, and a n-dodecenoyl group. Among them, from the viewpoint of reducing the molecular weight, the viewpoint of compatibility or solubility, and the viewpoint of ease of production, an alkenoyl group having 2 to 10 carbon atoms is preferred, and an alkenoyl group having 2 to 6 carbon atoms is more preferred.

An example of the divalent organic group represented by A is a group represented by the following formula (a).

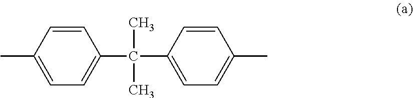

Specific examples of the compound (D-1) represented by the general formula (VI) include polyethylene glycol, polypropylene glycol, polytetramethylene glycol, polyoxytetramethylene polyoxyethylene glycol, polyoxyethylene polyoxypropylene glycol, polyoxyethylene monomethyl ether, polyoxyethylene dimethyl ether, polyoxyethylene-bisphenol A ether, polyoxypropylene-bisphenol A ether, polyoxyethylene-polyoxypropylene-bisphenol A ether, polyethylene glycol-allyl ether, polyethylene glycol-diallyl ether, polypropylene glycol-allyl ether, polypropylene glycol-diallyl ether, polyethylene glycol-polypropylene glycol-allyl ether, polyethylene glycol dimethacrylate, polypropylene glycol dimethacrylate, and polypropylene glycol distearate. Those compounds are commercial products, and, for example, “UNIOX (trademark)”, “UNIOL (trademark)”, “UNILUBE (trademark)”, “UNISAFE (trademark)”, “POLYCERIN (trademark)”, or “EPIOL (trademark)” manufactured by NOF Corporation may be used.

Examples of the polyhydric alcohol in the alkylene oxide adduct of a polyhydric alcohol and the ester thereof (D-2) include glycerin, diglyceryl ether, and sorbitol.

Specific examples of the cyclic polyether compound (D-3) include 18-crown-6 and dibenzo-18-crown-6.

As the polyether (D), at least one kind selected from polyethylene glycol, polypropylene glycol, polyoxytrimethylene glycol, polyoxytetramethylene glycol, polyoxyethylene glycol-polyoxypropylene glycol, polyoxytetramethylene glycol-polyoxypropylene glycol, and polyoxytetramethylene glycol-polyoxyethylene glycol is preferably used.

The number-average molecular weight of the polyether (D) is not particularly limited, but is preferably from 200 to 10,000, more preferably from 500 to 8,000, still more preferably from 1,000 to 5,000.

The polycarbonate-based resin composition of the present invention may include 0.02 part by mass or more and 2.0 parts by mass or less of the polyether compound (D) with respect to 100 parts by mass of the polycarbonate resin (A). When the content of the polyether compound (D) falls within the range, a molded article having an excellent color tone can be obtained and hence can be preferably used even in an optical molding application, and besides, flame retardancy can be satisfactorily maintained. The content of the polyether compound (D) is more preferably 0.05 part by mass or more, still more preferably 0.10 part by mass or more, still further more preferably 0.15 part by mass or more with respect to 100 parts by mass of the polycarbonate-based resin (A) from the viewpoint of obtaining an excellent color tone, and is preferably 1.50 parts by mass or less, more preferably 1.2 parts by mass or less, still more preferably 0.9 part by mass or less with respect thereto from the viewpoint of maintaining excellent flame retardancy. The above-mentioned polyether compounds (D) may be used alone or in combination thereof. When the composition includes a plurality of kinds of polyether compounds, their total amount falls within the ranges.

### Polytetrafluoroethylene (E)

The polytetrafluoroethylene (E) is not particularly limited, and a known polytetrafluoroethylene may be used. However, an aqueous dispersion-type polytetrafluoroethylene or an acryl-coated polytetrafluoroethylene is preferred. The use of the aqueous dispersion-type or acryl-coated polytetrafluoroethylene can suppress an appearance failure. For example, when a certain amount of a powdery polytetrafluoroethylene is used, there is a risk in that the polytetrafluoroethylene aggregates to form an aggregate, and the aggregate impairs the appearance of the molded article. Examples of the aqueous dispersion-type or acryl-coated polytetrafluoroethylene include “METABLEN A” series typified by “METABLEN A3000” (product name), “METABLEN A3750” (product name), and “METABLEN A3800” (product name) manufactured by Mitsubishi Chemical Corporation, “SN3705” (product name) manufactured by Shine Polymer, “BLENDEX B449” (product name) manufactured by GE Specialty Chemicals, “POLYFLON PTFE D-210C” (product name) manufactured by Daikin Industries, Ltd., and “Fluon PTFE AD” series typified by “Fluon PTFE AD939E” (product name) manufactured by AGC Inc.

The polytetrafluoroethylene (E) is preferably particulate. The average particle diameter of the polytetrafluoroethylene (E) is preferably 0.05 μm or more and 1.0 μm or less. When the average particle diameter falls within the range, the polytetrafluoroethylene can be suppressed from aggregating in the composition, and also be uniformly dispersed in the composition. The average particle diameter of the polytetrafluoroethylene (E) is more preferably 0.1 μm or more, still more preferably 0.15 μm or more, still further more preferably 0.20 μm or more, and is more preferably 0.50 μm or less, still more preferably 0.40 μm or less, still further more preferably 0.35 μm or less. The average particle diameter of the polytetrafluoroethylene is specifically measured by an electrophoretic light-scattering method.

The polycarbonate-based resin composition of the present invention preferably includes 1.0 part by mass or less of the polytetrafluoroethylene (E) with respect to 100 parts by mass of the polycarbonate-based resin (A). When the content of the polytetrafluoroethylene (E) falls within the range, an excellent color tone can be maintained. The amount of the polytetrafluoroethylene (E) is more preferably 0.50 part by mass or less, still more preferably 0.30 part by mass or less, still further more preferably 0.15 part by mass or less, still further more preferably 0.10 part by mass or less, still further more preferably 0.09 part by mass or less, still further more preferably 0.06 part by mass or less with respect to 100 parts by mass of the polycarbonate-based resin (A). In addition, from the viewpoint of flame retardancy, the content of the polytetrafluoroethylene (E) is preferably 0.01 part by mass or more, more preferably 0.03 part by mass or more, still more preferably 0.05 part by mass or more with respect to 100 parts by mass of the polycarbonate-based resin (A). The above-mentioned polytetrafluoroethylenes (E) may be used alone or in combination thereof. When the composition includes a plurality of kinds of polytetrafluoroethylenes, their total amount falls within the ranges.

In the case of an acryl-coated polytetrafluoroethylene or an aqueous dispersion-type polytetrafluoroethylene, the amount of the polytetrafluoroethylene excluding an acryl-coating part or a water part serving as a dispersion medium falls within the ranges. The polycarbonate-based resin composition of the present invention may not include the polytetrafluoroethylene (E) depending on, for example, the applications of a molded article using the resin composition, and in that case, does not have a problem of a reduction in color tone due to the incorporation of the polytetrafluoroethylene (E).

### Alicyclic Epoxy Compound (F)

The polycarbonate-based resin composition of the present invention may include an alicyclic epoxy compound (F). When the composition includes the alicyclic epoxy compound (F), the long-term moist heat resistance and long-term heat resistance of a molded article to be obtained can be further improved, and hence a satisfactory color tone can be maintained with less yellowing.

The alicyclic epoxy compound refers to a cyclic aliphatic compound having an alicyclic epoxy group, that is, an epoxy group obtained through addition of one oxygen atom to an ethylene bond in an alicycle, and specifically, compounds represented by the following formulae (F-1) to (F-10) are suitably used.

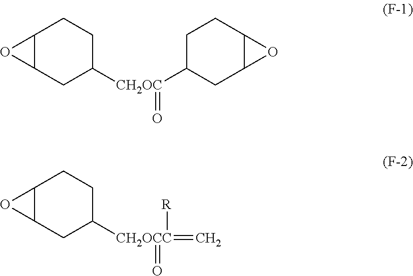

wherein R represents H or CH₃.

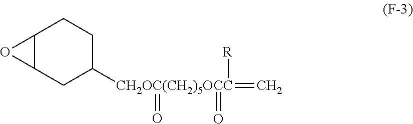

wherein R represents H or CH₃.

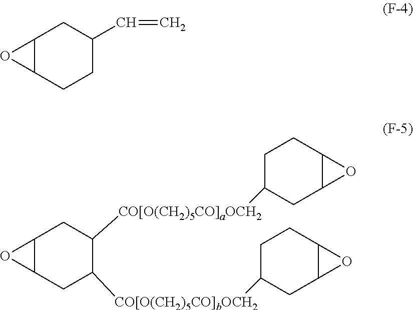

wherein a+b=1 or 2.

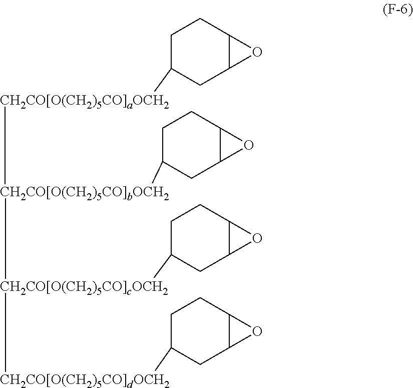

wherein a+b+c+d=1 or more and 3 or less.

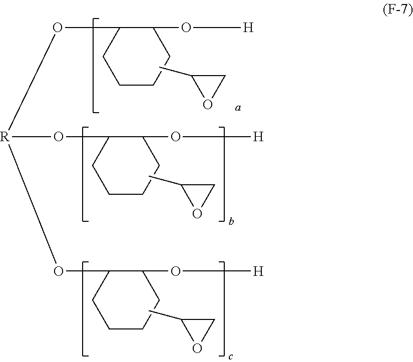

wherein a+b+c=n (integer), and R represents a hydrocarbon group.

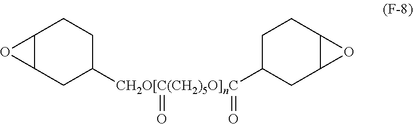

wherein “n” represents an integer.

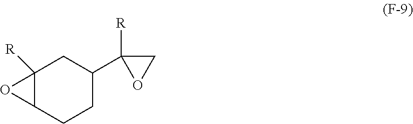

wherein R represents a hydrocarbon group.

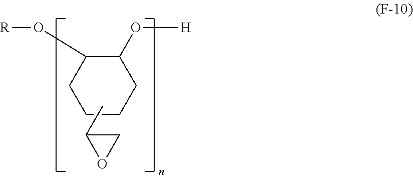

wherein “n” represents an integer, and R represents a hydrocarbon group.

Among the above-mentioned alicyclic epoxy compounds, in terms of being excellent in compatibility with the polycarbonate-based resin (A) so as not to impair the transparency or the color tone, one or more kinds selected from the group consisting of compounds represented by the formula (F-1), the formula (F-7), and the formula (F-10) are preferred, one or more kinds selected from the group consisting of compounds represented by the formula (F-1) and the formula (F-10) are more preferred, and the compound represented by the formula (F-1) is still more preferred. For example, the compound represented by the formula (F-1) is available as 3′,4′-epoxycyclohexylmethyl-3,4-epoxycyclohexanecarboxylate (“CELLOXIDE 2021P” manufactured by Daicel Corporation). The compound represented by the formula (F-10) is available as a 1,2-epoxy-4-(2-oxiranyl)cyclohexane adduct of 2,2-bis(hydroxymethyl)-1-butanol (“EHPE3150” manufactured by Daicel Corporation).

As a mixture of “CELLOXIDE 2021P” and “EHPE3150”, “EHPE3150CE”, which is commercially available from Daicel Corporation, may also be preferably used.

The content of the alicyclic epoxy compound serving as the component (F) in the polycarbonate resin composition is preferably 0.01 part by mass or more, more preferably 0.03 part by mass or more, still more preferably 0.04 part by mass or more with respect to 100 parts by mass of the component (A), and is preferably 0.15 part by mass or less, more preferably 0.10 part by mass or less with respect thereto. When the content of the alicyclic epoxy compound serving as the component (F) in the polycarbonate resin composition falls within the ranges, improving effects on long-term moist heat resistance and long-term heat resistance are sufficiently obtained. The above-mentioned alicyclic epoxy compounds (F) may be used alone or in combination thereof. When the composition includes a plurality of kinds of alicyclic epoxy compounds, their total amount falls within the ranges.

### UV Absorber (G)

The polycarbonate-based resin composition of the present invention may include a UV absorber (G). As the UV absorber (G), for example, a benzophenone-based, benzotriazole-based, hydroxyphenyltriazine-based, cyclic imino ester-based, or cyanoacrylate-based UV absorber may be used. Examples of the benzophenone-based UV absorber may include 2,4-dihydroxybenzophenone, 2-hydroxy-4-methoxybenzophenone, 2-hydroxy-4-octoxybenzophenone, 2-hydroxy-4-benzyloxybenzophenone, 2-hydroxy-4-methoxy-5-sulfoxybenzophenone, 2-hydroxy-4-methoxy-5-sulfoxytrihydridobenzophenone, 2,2′-dihydroxy-4-methoxybenzophenone, 2,2′,4,4′-tetrahydroxybenzophenone, 2,2′-dihydroxy-4,4′-dimethoxybenzophenone, 2,2′-dihydroxy-4,4′-dimethoxy-5-sodiumsulfoxybenzophenone, bis(5-benzoyl-4-hydroxy-2-methoxyphenyl)methane, 2-hydroxy-4-n-dodecyloxybenzophenone, and 2-hydroxy-4-methoxy-2′-carboxybenzophenone.

Examples of the benzotriazole-based UV absorber (G) may include 2-(2′-hydroxy-5′-tert-octylphenyl)benzotriazole, 2-(2-hydroxy-5-methylphenyl)benzotriazole, 2-(2-hydroxy-5-tert-octylphenyl)benzotriazole, 2-(2-hydroxy-3,5-dicumylphenyl)phenylbenzotriazole, 2-(2-hydroxy-3-tert-butyl-5-methylphenyl)-5-chlorobenzotriazole, 2,2′-methylenebis[4-(1,1,3,3-tetramethylbuty)-6-(2H-benzotriazol-2-yl)phenol], 2-(2-hydroxy-3,5-di-tert-butylphenyl)benzotriazole, 2-(2-hydroxy-3,5-di-tert-butylphenyl)-5-chlorobenzotriazole, 2-(2-hydroxy-3,5-di-tert-amylphenyl)benzotriazole, 2-(2-hydroxy-5-tert-octylphenyl)benzotriazole, 2-(2-hydroxy-5-tert-butylphenyl)benzotriazole, 2-(2-hydroxy-4-octoxyphenyl)benzotriazole, 2,2′-methylenebis(4-cumyl-6-benzotriazolephenyl), 2,2′-p-phenylenebis(1,3-benzoxazin-4-one), and 2-[2-hydroxy-3-(3,4,5,6-tetrahydrophthalimideomethyl)-5-methylphenyl]benzotriazole, and polymers each having a 2-hydroxyphenyl-2H-benzotriazole skeleton, such as a copolymer of 2-(2′-hydroxy-5-methacryloxyethylphenyl)-2H-benzotriazole and a vinyl-based monomer copolymerizable with the monomer, and a copolymer of 2-(2′-hydroxy-5-acryloxyethylphenyl)-2H-benzotriazole and a vinyl-based monomer copolymerizable with the monomer. Among them, 2-(2′-hydroxy-5′-tert-octylphenyl)benzotriazole is preferably used.

Examples of the hydroxyphenyltriazine-based UV absorber include 2-(4,6-diphenyl-1,3,5-triazin-2-yl)-5-hexyloxyphenol, 2-(4,6-diphenyl-1,3,5-triazin-2-yl)-5-methyloxyphenol, 2-(4,6-diphenyl-1,3,5-triazin-2-yl)-5-ethyloxyphenol, 2-(4,6-diphenyl-1,3,5-triazin-2-yl)-5-propyloxyphenol, and 2-(4,6-diphenyl-1,3,5-triazin-2-yl)-5-butyloxyphenol. Examples thereof may also include compounds each obtained by changing a phenyl group of each of the exemplified compounds to a 2,4-dimethylphenyl group, such as 2-(4,6-bis(2,4-dimethylphenyl)-1,3,5-triazin-2-yl)-5-hexyloxyphenol.

Examples of the cyclic imino ester-based UV absorber may include 2,2′-p-phenylenebis(3,1-benzoxazin-4-one), 2,2′-m-phenylenebis(3,1-benzoxazin-4-one), 2,2′-p,p′-diphenylenebis(3,1-benzoxazin-4-one), and 2,2′-(1,4-phenylene)bis[4H-3,1-benzoxazin-4-one]. Among them, 2,2′-(1,4-phenylene)bis[4H-3,1-benzoxazin-4-one] is preferably used.

Examples of the cyanoacrylate-based UV absorber may include 1,3-bis-[(2′-cyano-3′,3′-diphenylacryloyl)oxy]-2,2-bis[(2-cyano-3,3-diphenylacryloyl)oxy]methylpropane and 1,3-bis-[(2-cyano-3,3-diphenylacryloyl)oxy]benzene.

The UV absorber (G) may have the structure of a radically polymerizable monomer compound, and be a polymer-type UV absorber obtained by copolymerizing any such UV-absorbable monomer and a monomer such as an alkyl (meth)acrylate. Such UV-absorbable monomer is suitably a compound containing, in the ester substituent of a (meth)acrylic acid ester, a benzotriazole skeleton, a benzophenone skeleton, a triazine skeleton, a cyclic imino ester skeleton, or a cyanoacrylate skeleton. Among them, a compound containing a cyclic imino ester skeleton is preferred, and 2,2′-(1,4-phenylene)bis[4H-3,1-benzoxazin-4-one] is preferably used because this compound can suppress coloration due to the UV absorber to improve the color tone. The UV absorbers may be used alone or in combination thereof. A benzophenone-based UV absorber and a benzotriazole-based UV absorber are preferably used as the UV absorber, and it is preferred that the benzophenone-based UV absorber and the benzotriazole-based UV absorber be each used alone or used in combination with each other.

The polycarbonate resin composition of the present invention includes preferably 0.05 part by mass or more, more preferably 0.10 part by mass or more, still more preferably 0.15 part by mass or more, and preferably 1 part by mass or less, more preferably 0.50 part by mass or less, still more preferably 0.30 part by mass or less of the UV absorber (G) with respect to 100 parts by mass of the polycarbonate-based resin (A), though the optimum value varies depending on the thickness of a molded article. When the content of the UV absorber (G) falls within the ranges, weatherability can be satisfactorily maintained. The above-mentioned UV absorbers (G) may be used alone or in combination thereof. When the composition includes a plurality of kinds of UV absorbers, their total amount falls within the ranges.

### Diffuser (H)

The polycarbonate-based resin composition of the present invention may include a diffuser (H). The diffuser (H) is blended in order to impart a light-diffusing effect, and is not particularly limited, and a known light diffuser may be used. Examples thereof include a crosslinked acrylic resin, a crosslinked polystyrene resin, a silicone resin, a fluorine-based resin, silica, quartz, titanium oxide, and zinc oxide.

Among them, a Si-based light diffuser is preferred because the Si-based light diffuser can aid the expression of flame retardancy and impart a light-diffusing effect. The Si-based light diffuser is not particularly limited as long as the light diffuser contains silicon (Si), and a known Si-based light diffuser may be used. Examples thereof include a silicone-based elastomer and a silicone resin. Among them, organic fine particles formed of a silicone resin are preferred because the organic fine particles have good residence thermal stability during molding or the like and have a flame retardancy-improving effect, and the particle diameter thereof is preferably from 0.5 μm to 10 μm, more preferably from 1 μm to 5 μm.

The content of the diffuser (H) in the polycarbonate resin composition in the present invention is preferably from 0.1 part by mass to 5.0 parts by mass, more preferably from 0.1 part by mass to 4.0 parts by mass, still more preferably from 0.1 part by mass to 3.0 parts by mass with respect to 100 parts by mass of the polycarbonate-based resin (A), though the optimum value varies depending on the thickness of a molded article. When the content of the light diffuser falls within the ranges, sufficient diffusion performance is obtained, and at the same time, the strength of a molded article can be sufficiently maintained.

### Antioxidant

The polycarbonate-based resin composition of the present invention may include the antioxidant as required. A known antioxidant may be used as the antioxidant, and a phenol-based antioxidant and a phosphorus-based antioxidant may be preferably used. The antioxidants may be used alone or in combination thereof. The diphosphite compound (B) represented by the formula (I) is not included in the following antioxidants.

Examples of the phenol-based antioxidant include triethylene glycol-bis[3-(3-tert-butyl-5-methyl-4-hydroxyphenyl)propionate], 1,6-hexanediol-bis[3-(3,5-di-tert-butyl-4-hydroxyphenyl)propionate], pentaerythritol-tetrakis[3-(3,5-di-tert-butyl-4-hydroxyphenyl)propionate], octadecyl-3-(3,5-di-tert-butyl-4-hydroxyphenyl)propionate, 1,3,5-trimethyl-2,4,6-tris(3,5-di-tert-butyl-4-hydroxybenzyl)benzene, N,N-hexamethylenebis(3,5-di-tert-butyl-4-hydroxy-hydrocinnamide), 3,5-di-tert-butyl-4-hydroxy-benzylphosphonate diethyl ester, tris(3,5-di-tert-butyl-4-hydroxybenzyl)isocyanurate, and 3,9-bis[1,1-dimethyl-2-[β-(3-tert-butyl-4-hydroxy-5-methylphenyl)propionyloxy]ethyl]-2,4,8,10 -tetraoxaspiro(5,5)undecane.

Specifically, examples of the phenol-based antioxidant may include commercial products such as “Irganox 1010” (manufactured by BASF Japan, trademark), “Irganox 1076” (manufactured by BASF Japan, trademark), “Irganox 1330” (manufactured by BASF Japan, trademark), “Irganox 3114” (manufactured by BASF Japan, trademark), “Irganox 3125” (manufactured by BASF Japan, trademark), “BHT” (manufactured by Takeda Pharmaceutical Company Limited., trademark), “Cyanox 1790” (manufactured by Cyanamid, trademark), and “Sumilizer GA-80” (manufactured by Sumitomo Chemical Company, Limited, trademark).

Examples of the phosphorus-based antioxidant include triphenyl phosphite, diphenyl nonyl phosphite, diphenyl (2-ethylhexyl) phosphite, tris(2,4-di-tert-butylphenyl) phosphite, tris(nonylphenyl) phosphite, diphenyl isooctyl phosphite, 2,2′-methylenebis(4,6-di-tert-butylphenyl)octyl phosphite, diphenyl isodecyl phosphite, diphenyl mono(tridecyl) phosphite, phenyl diisodecyl phosphite, phenyl di(tridecyl) phosphite, tris(2-ethylhexyl) phosphite, tris(isodecyl) phosphite, tris(tridecyl) phosphite, dibutyl hydrogen phosphite, trilauryl trithiophosphite, tetrakis(2,4-di-tert-butylphenyl)-4,4′-biphenylene diphosphonite, 4,4′-isopropylidenediphenol dodecyl phosphite, 4,4′-isopropylidenediphenol tridecyl phosphite, 4,4′-isopropylidenediphenol tetradecyl phosphite, 4,4′-isopropylidenediphenol pentadecyl phosphite, 4,4′-butylidenebis(3-methyl-6-tert-butylpheny)ditridecyl phosphite, bis(2,6-di-tert-butyl-4-methylphenyl)pentaerythritol diphosphite, bis(nonylphenyl)pentaerythritol diphosphite, distearyl-pentaerythritol diphosphite, phenyl bisphenol A pentaerythritol diphosphite, tetraphenyl dipropylene glycol diphosphite, 1,1,3-tris(2-methyl-4-di-tridecylphosphite-5-tert-butylphenyl)butane, 3,4,5,6-dibenzo-1,2-oxaphosphane, triphenylphosphine, diphenylbutylphosphine, diphenyloctadecylphosphine, tris(p-tolyl)phosphine, tris(p-nonylphenyl)phosphine, tris(naphthyl)phosphine, diphenyl(hydroxymethyl)phosphine, diphenyl(acetoxymethyl)phosphine, diphenyl (β-ethylcarboxyethyl)phosphine, tris(p-chlorophenyl)phosphine, tris(p-fluorophenyl)phosphine, benzyldiphenylphosphine, diphenyl(β-cyanoethyl)phosphine, diphenyl(p-hydroxyphenyl)phosphine, diphenyl(1,4-dihydroxyphenyl)-2-phosphine, and phenylnaphthylbenzylphosphine.

Specifically, examples of the phosphorus-based antioxidant may include commercial products such as “Irgafos 168” (manufactured by BASF Japan, trademark), “Irgafos 12” (manufactured by BASF Japan, trademark), “Irgafos 38” (manufactured by BASF Japan, trademark), “ADK STAB 329K” (manufactured by ADEKA Corporation, trademark), “ADK STAB PEP-36” (manufactured by ADEKA Corporation, trademark), “ADK STAB PEP-8” manufactured by ADEKA Corporation, trademark), “Sandstab P-EPQ” (manufactured by Clariant, trademark), “Weston 618” (manufactured by GE, trademark), “Weston 619G” (manufactured by GE, trademark), and “Weston 624” (manufactured by GE, trademark).

The antioxidants may be used alone or in combination thereof. The content of the antioxidant in the polycarbonate-based resin composition is preferably 0.01 part by mass or more, more preferably 0.02 part by mass or more with respect to 100 parts by mass of the polycarbonate-based resin (A), and is preferably 0.5 part by mass or less, more preferably 0.2 part by mass or less with respect thereto. A case in which the content falls within the ranges is preferred because the thermal stability in a molding step or the like and the long-term thermal stability of a molded article can be maintained, and hence a reduction in molecular weight is hardly caused. When a plurality of kinds of antioxidants are used, their total amount falls within the ranges.

By virtue of having the composition described above, the polycarbonate-based resin composition of the present invention can be excellent in both of color tone and flame retardancy, in particular, thin-wall flame retardancy. Its color tone and flame retardancy are specifically as described below, while details thereof are described in Examples.

### <<Color Tone>>

When the composition is free of any polytetrafluoroethylene and is molded to have a thickness of 1.0 mm (1.0 mmt), its initial YI value can be set to 1.3 or less. In the case of being free of any polytetrafluoroethylene, the composition more preferably has an initial YI value of 1.2 or less when molded to have a thickness of 1.0 mm.

In the case where the polycarbonate-based resin composition of the present invention includes the polytetrafluoroethylene, when the composition includes 0.10 part by mass or less of the polytetrafluoroethylene (E) and is molded to have a thickness of 1.0 mm, its initial YI value can be set to 3.5 or less, and when the composition includes 0.15 part by mass or less of the polytetrafluoroethylene (E) and is molded to have a thickness of 1.0 mm, its initial YI value can be set to 4.6 or less. Herein, the amount of the “polytetrafluoroethylene” means the substantial amount of the fluorine-containing compound excluding the acryl-coating part or the water part. From the viewpoint of achieving both of excellent flame retardancy and a satisfactory color tone, the initial YI value when the composition is molded to have a thickness of 1.0 mm is preferably 4.6 or less, more preferably 3.7 or less, still more preferably 3.0 or less, still further more preferably 2.5 or less in the case of including 0.09 part by mass or less of the polytetrafluoroethylene (E).

### <<Flame Retardancy>>

When the polycarbonate-based resin composition of the present invention is molded to have a thickness of 1.0 mm, thin-wall flame retardancy at an extremely high level of V-0 can be achieved under a UL94 standard. Depending on the composition that the polycarbonate-based resin composition of the present invention may adopt, even when the composition is molded to have a thickness of 0.75 mm, V-0 can be achieved under the UL94 standard.

### Method of Producing Polycarbonate-based Resin Composition

A molded article formed of the polycarbonate-based resin composition of the present invention may be obtained by blending and kneading the above-mentioned components, and molding the resultant.

A kneading method is not particularly limited, and an example thereof is a method using, for example, a ribbon blender, a Henschel mixer, a Banbury mixer, a drum tumbler, a single-screw extruder, a twin-screw extruder, a cokneader, or a multi-screw extruder. In addition, a heating temperature at the time of the kneading is selected from the range of typically from 240° C. to 330° C., preferably from 250° C. to 320° C.

In this case, the blending is preferably performed so that the branching ratio of the polycarbonate-based resin (A) may be 0.01 mol % or more and 3.0 mol % or less. The branched polycarbonate-based resin (A-1) and the aromatic polycarbonate-based resin (A-2) except the resin (A-1) may be blended so that the branching ratio of the polycarbonate-based resin (A) may be more preferably 0.3 mol % or more, still more preferably 0.5 mol % or more, still further more preferably 0.7 mol % or more, still further more preferably 1.0 mol % or more, still further more preferably 1.4 mol % or more, particularly preferably 1.5 mol % or more, and more preferably 2.8 mol % or less, still more preferably 2.6 mol % or less, still further more preferably 2.3 mol % or less, still further more preferably 2.0 mol % or less. When the branching ratio in the polycarbonate-based resin (A) falls within the ranges, a polycarbonate-based resin composition excellent in flame retardancy, specifically excellent in thin-wall flame retardancy is obtained.

A component to be incorporated except the polycarbonate-based resin may be added after having been melt-kneaded together with the polycarbonate-based resin or any other thermoplastic resin in advance, that is, as a master batch.

### Molded Article

A molded article formed of the polycarbonate-based resin composition of the present invention may be obtained by molding the polycarbonate-based resin composition of the present invention.

Various conventionally known molding methods may each be used as a molding method, and examples thereof include an injection molding method, an injection compression molding method, an extrusion molding method, a profile extrusion molding method, a blow molding method, a press molding method, a vacuum molding method, and an expansion molding method.

A component to be incorporated except the polycarbonate-based resin may be added after having been melt-kneaded together with the polycarbonate-based resin or any other thermoplastic resin in advance, that is, as a master batch.

It is preferred that the polycarbonate-based resin composition be pelletized, and molding be performed using the pellet. A general molding method, such as an injection molding method, an injection compression molding method, or an extrusion molding method, or a special molding method, such as a gas-assisted molding method or a profile extrusion molding method, may be used. Thus, various molded articles can be produced.

When the molded article of the present invention is used as an appearance member, a molding technology for an improvement in appearance, such as a heat cycle molding method, a high-temperature mold, or a heat-insulating mold, is preferably used.

The molded article obtained by molding the polycarbonate-based resin composition of the present invention is excellent in flame retardancy, transparency, and color tone, and hence can be suitably used as various optical molded articles, for example, lighting equipment diffusion covers each made of a resin, such as a lighting cover and a display cover, and a lens. Further, the molded article is also suitably used as, for example, a lighting cover for a streetlight and a lens each of which is used in a high-temperature and high-humidity environment.

### EXAMPLES

Now, the present invention is described in more detail by way of Examples. However, the present invention is by no means limited by these Examples.

The following raw materials were used in Examples and Comparative Examples.

### (A) Polycarbonate (PC)-based Resin

### (A-1) Branched Polycarbonate-based Resin (Branched PC)

### Production Example 1 (Production of Branched PC1: 2.30 mol % of THPE) (Polycarbonate Oligomer (i) Synthesis Step)

Sodium dithionite was added in an amount of 2,000 ppm by mass with respect to bisphenol A (BPA) to be dissolved later to 5.6 wt % aqueous sodium hydroxide, and BPA was dissolved in the mixture so that the concentration of BPA became 13.5 wt %. Thus, a solution of BPA in aqueous sodium hydroxide was prepared.

Sodium dithionite was added in an amount of 2,000 ppm by mass with respect to 1,1,1-tris(4-hydroxyphenylethane) (THPE) to be dissolved later to 5.6 wt % aqueous sodium hydroxide, and THPE was dissolved in the mixture so that the concentration of THPE became 11.3 wt %. Thus, a solution of THPE in aqueous sodium hydroxide was prepared.

The solution of BPA in aqueous sodium hydroxide, the solution of THPE in aqueous sodium hydroxide, methylene chloride, and phosgene were continuously passed through a tubular reactor having an inner diameter of 6 mm and a tube length of 30 m at flow rates of 42 L/hr, 2.32 L/hr, 15 L/hr, and 4.0 kg/hr, respectively. The tubular reactor had a jacket portion and the temperature of the reaction liquid was kept at 40° C. or less by passing cooling water through the jacket.

The reaction liquid that had exited the tubular reactor was continuously introduced into a baffled vessel-type reactor provided with a sweptback blade and having an internal volume of 40 L. 2.8 L/hr of the solution of BPA in aqueous sodium hydroxide, 0.07 L/hr of 25 wt % aqueous sodium hydroxide, 17 L/hr of water, 0.69 L/hr of a 1 wt % aqueous solution of triethylamine, and 6.5 L/hr of a solution of p-tert-butylphenol (PTBP) in methylene chloride (concentration: 4.0 wt %) were further added to the reactor to perform a reaction.

An aqueous phase was separated and removed by continuously taking out the reaction liquid overflowing the vessel-type reactor and leaving the reaction liquid at rest. Then, a methylene chloride phase was collected.

The resultant polycarbonate oligomer had a concentration of 334 g/L and a chloroformate group concentration of 0.73 mol/L.

### (Step of Producing Polycarbonate-based Resin)

15 L of the previously obtained polycarbonate oligomer solution, 10.2 L of methylene chloride, and 2.8 mL of triethylamine were loaded into a 50-liter vessel-type reactor including a baffle board, a paddle-type stirring blade, and a cooling jacket, and were mixed with each other.

A solution of BPA in aqueous sodium hydroxide (prepared by dissolving 1,166 g of BPA in an aqueous solution prepared by dissolving 639 g of NaOH and 2.3 g of sodium dithionite in 9.3 L of water) was added to the mixed liquid to perform a polymerization reaction for 60 minutes.

10 L of methylene chloride was added to the resultant for dilution and the mixture was stirred for 10 minutes. After that, the mixture was separated into an organic phase containing a polycarbonate resin, and an aqueous phase containing excess amounts of BPA and NaOH, and the organic phase was isolated.

The solution of the resultant polycarbonate in methylene chloride was sequentially washed with 0.03 mol/L aqueous sodium hydroxide and 0.2 N hydrochloric acid in amounts of 15 vol % each with respect to the solution. Next, the solution was repeatedly washed with pure water until an electric conductivity in an aqueous phase after the washing became 0.01 μS/m or less. The solution of the polycarbonate-based resin in methylene chloride obtained by the washing was concentrated and pulverized, and the flake was dried under reduced pressure at 120° C.

The branching ratio of the resultant branched PC1 determined by ¹H-NMR was 2.30 mol %, and the viscosity-average molecular weight Mv thereof measured in conformity with ISO 1628-4 (1999) was 23,000.

### Production Example 2: (Production of Branched PC2: 0.90 mol % of THPE)

A branched polycarbonate-based resin 2 was obtained by the same method as that of Production Example 1 except that, in the polycarbonate oligomer synthesis step, the supply amount of the solution of THPE in aqueous sodium hydroxide was set to 0.87 L/hr and the supply amount of the solution of PTBP in methylene chloride (concentration: 4.0 wt %) was set to 4.6 L/hr. The polycarbonate oligomer obtained in the polycarbonate oligomer synthesis step had a concentration of 330 g/L and a chloroformate group concentration of 0.72 mol/L.

The branching ratio determined by ¹H-NMR was 0.90 mol %, and the viscosity-average molecular weight My thereof measured in conformity with ISO 1628-4 (1999) was 22,800.

### (A-2): Aromatic Polycarbonate-based Resin

TARFLON FN2500A [manufactured by Idemitsu Kosan Co., Ltd., homopolycarbonate produced from bisphenol A, viscosity-average molecular weight=23,500]
TARFLON FN1700 [manufactured by Idemitsu Kosan Co., Ltd., homopolycarbonate produced from bisphenol A, viscosity-average molecular weight=17,700]

### (B): Diphosphite Compound

“Doverphos S-9228PC” (manufactured by Dover Chemical, bis(2,4-dicumylphenyl)pentaerythritol diphosphite, abbreviated as Dover28 in the tables)

### Other Additives

### (C) Organic Alkali(ne Earth) Metal Salt

Nonafluorobutanesulfonic acid potassium salt [manufactured by Mitsubishi Materials Corporation, product name: “Eftop KFBS”]

### (D) Polyether Having Polyoxyalkylene Structure

PEG-PPG “UNILUBE 50DE-25” (manufactured by NOF Corporation, polyoxyethylene glycol-polyoxypropylene glycol, Mn=1,750)

### (E) Polytetrafluoroethylene

PTFE (water dispersion of PTFE), Polyflon D210C [manufactured by Daikin Industries, Ltd.: 60 mass % of polytetrafluoroethylene, average particle diameter: 0.22 μm]

### (F) Alicyclic Epoxy Compound

“CELLOXIDE 2021P” (manufactured by Daicel Chemical Industries, Ltd., 3,4-epoxycyclohexylmethyl-3′,4′-epoxycyclohexanecarboxylate, abbreviated as 2021P in the tables)

### (G) UV Absorber

(G1) “ChemiSorb 79” (manufactured by Chemipro Kasei Kaisha, Ltd., 2-(2′-hydroxy-5′-tert-octylphenyl)benzotriazole)
(G2) “Cyasorb UV-3638” (manufactured by Cytec Industries Inc., 2,2′-(1,4-phenylene)bis[4H-3,1-benzoxazin-4-one]), abbreviated as UV-3638 in the tables)

### (H) Diffuser

“KMP590” (manufactured by Shin-Etsu Chemical Co., Ltd., crosslinked silicone resin particles, average particle diameter: 5 μm)

### Antioxidant

“Irgafos 168” [manufactured by BASF Japan, tris(2,4-di-tert-butylphenyl) phosphite, abbreviated as Irg 168 in the tables]
“ADK STAB PEP-36” (manufactured by ADEKA Corporation, bis(2,6-di-tert-butyl-4-methylphenyl)pentaerythritol diphosphite, abbreviated as PEP-36 in the tables)

In the following, in each of Examples and Comparative Examples, evaluations (1) to (4) were performed as described below.

### (1) Melt Viscosity of Polycarbonate-based Resin (A)

The branched polycarbonate-based resin (A-1) and the aromatic polycarbonate-based resin (A-2) except the resin (A-1) were mixed at the ratio of each of Examples and Comparative Examples to be described later to provide a flake of the polycarbonate-based resin (A). The resultant flake was dried at 120° C. for 4 hours or more, and then measured for its melt viscosity with a capillary rheometer (Toyo Seiki Seisaku-sho, Ltd., CAPILOGRAPH 1C) at a measurement temperature of 280° C. and a shear rate ranging from 1 s⁻¹ to 100 s⁻¹ in conformity with JIS K 7199:1999. The melt viscosity of the polycarbonate-based resin (A) at a shear rate of 10 s⁻¹ was determined from the measurement results thus obtained.

### (2) Branching Ratio of Polycarbonate-based Resin (A)

The branching ratio of a polycarbonate-based resin (A) was determined through ¹H-NMR measurement. The branching ratio was determined as “number of moles of structural unit derived from branching agent/total number of moles of (structural unit derived from dihydric phenol+structural unit derived from branching agent+terminal unit)×100” (represented in the unit of mol %).

### (3) Viscosity-average Molecular Weight of Polycarbonate-based Resin Composition

The viscosity-average molecular weight My of a polycarbonate-based resin composition was calculated from the following Schnell's equation by measuring the limiting viscosity [η] of a methylene chloride solution at 20° C. with an Ubbelohde-type viscosity tube. The viscosity-average molecular weight of the “polycarbonate-based resin composition” was measured using a resin solution obtained in the following manner: a pellet of a polycarbonate resin composition obtained by mixing and melt-kneading the respective components at the ratio of each of Examples and Comparative Examples to be described later was dissolved in a methylene chloride, and the resultant was subjected to solid-liquid separation.

[η]=1.23×10⁻⁵Mv^{0.83}

### (4) Flame Retardancy

The respective components were mixed and melt-kneaded at the ratio of each of Examples and Comparative Examples to be described later to provide a pellet. In conformity with UL Standard 94, a test piece having a length of 127 mm, a width of 12.7 mm, and a thickness of 1 mm was produced from the resultant pellet and subjected to a vertical flame test. For each of Examples 1-9 to 1-13 and Comparative Examples 1-3 and 1-4 to be described later, a vertical flame test was also performed using a test piece having a length of 127 mm, a width of 12.7 mm, and a thickness of 0.75 mm. Flame retardancy was evaluated by being classified as rank V-0, V-1, V-2, or Not-V on the basis of the result of the test.

The UL Standard 94 is a method of evaluating flame retardancy from an afterflame time after the flame of a burner has been brought into contact with a test piece having a predetermined size, which has been vertically held.

### Examples 1-1 to 1-8 and Comparative Examples 1-1 and 1-2

Respective components were mixed at ratios shown in Table 1, and each of the mixtures was supplied to a vented twin-screw extrusion molding machine [manufactured by Toshiba Machine Co., Ltd.: TEM37SS], and was melt-kneaded at a barrel temperature of from 270° C. to 280° C., a screw revolution number of 300 rpm, and an ejection amount of 50 kg/hr to provide an evaluation pellet sample. The resultant pellet was dried at 120° C. for 5 hours, and then subjected to the above-mentioned various measurements and various YI value evaluations to be described later. The results are shown in Table 1.

### (5-1) Initial YI Value of Molded Article

The pellet after the drying was molded with an injection molding machine [MD50X manufactured by Niigata Machine Techno Co., Ltd.] at a molding temperature of 310° C. and a mold temperature of 95° C. to produce a test piece that was a three-stage plate measuring 90 mm×50 mm (3-millimeter thick portion: 45 mm×50 mm, 2-millimeter thick portion: 22.5 mm×50 mm, 1-millimeter thick portion: 22.5 mm×50 mm).

The resultant test piece was measured for its YI value (initial YI value: YI₁) with “Color-Eye 7000A” manufactured by Videojet X-Rite K.K. under the conditions of a C light source and a two-degree field of view. The results are shown in Table 1. Evaluation was performed as follows: a case in which the YI₁ was 3.0 or less was graded AA, a case in which the YI₁ was more than 3.0 and 3.5 or less was graded A, and a case in which the YI₁ was more than 3.5 was graded B.

### (5-2) Moist Heat Resistance Test of Molded Article

The flat plate-shaped test piece after the YI₁ measurement was placed in a thermohygrostat set to a temperature of 85° C. and a relative humidity of 85% for 500 hours and 1,000 hours. The test piece after the test was measured for each of its YI value after 500 hours (YI₂⁵⁰⁰) and YI value after 1,000 hours (YI₂¹⁰⁰⁰) in the same manner as above. The results are shown in Table 1. Evaluation was performed as follows: a case in which each of the YI₂⁵⁰⁰ and the YI₂¹⁰⁰⁰ was 3.0 or less was graded AA, a case in which each thereof was more than 3.0 and 3.5 or less was graded A, a case in which each thereof was more than 3.5 and 4.0 or less was graded B, a case in which each thereof was more than 4.0 and 4.5 or less was graded C, and a case in which each thereof was more than 4.5 was graded D.

### (5-3) Heat Resistance Test of Molded Article

The flat plate-shaped test piece after the YI₁ measurement was placed in an oven adjusted to a temperature of 120° C. for 1,000 hours. The test piece after the test was measured for its YI value after 1,000 hours (YI₃) in the same manner as above. The results are shown in Table 1. A case in which the YI₃ was 3.0 or less was graded AA, a case in which the YI₃ was more than 3.0 and 3.5 or less was graded A, a case in which the YI₃ was more than 3.5 and 4.0 or less was graded B, a case in which the YI₃ was more than 4.0 and 4.5 or less was graded C, and a case in which the YI₃ was more than 4.5 was graded D.

### (5-4) Moist Heat Resistance Evaluation (ΔYI) of Molded Article

The moist heat resistance evaluation of a molded article was performed as described below. Evaluation was performed on the basis of a difference between the initial YI value (YI₁) of the molded article obtained in (5-1) above and each of the YI values: (YI₂⁵⁰⁰) and (YI₂¹⁰⁰⁰) obtained after (5-2) Moist Heat Resistance Test of Molded Article. Acceptance criteria for the moist heat resistance evaluation were as follows: a case in which each of Δ(YI₂⁵⁰⁰−YI₁) and Δ(YI₂¹⁰⁰⁰−(YI₁) was 0.4 or less was graded AA, a case in which each thereof was more than 0.4 and 0.9 or less was graded A, and a case in which each thereof was more than 0.9 was graded B.

### (5-5) Heat Resistance Evaluation (ΔYI) of Molded Article

The heat resistance evaluation of a molded article was performed as described below. Evaluation was performed on the basis of a difference between the initial YI value (YI₁) of the molded article obtained in (5-1) above and the YI value (YI₃) obtained after (5-3) Heat Resistance Test of Molded Article. Acceptance criteria for the heat resistance evaluation were as follows: a case in which Δ(YI₃−YI₁) was 0.4 or less was graded AA, a case in which Δ(YI₃−YI₁) was more than 0.4 and 0.9 or less was graded A, and a case in which Δ(YI₃−YI₁) was more than 0.9 was graded B.

TABLE 1

| | | | Example | | | | |
|---|---|---|---|---|---|---|---|
| | | | 1-1 | 1-2 | 1-3 | 1-4 | 1-5 |
| PC-based resin (A) | | | | | | | |
| (A-1) | Branched PC1 | mass % | | | | | 70 |
| | (2.3 mol %) | | | | | | |
| | Branched PC2 | mass % | 70 | 70 | 70 | 70 | |
| | (0.9 mol %) | | | | | | |
| (A-2) | FN2500A | mass % | 30 | 30 | 30 | 30 | 30 |
| | FN1700 | mass % | | | | | |
| Melt viscosity | | Pa · s | 4,200 | 4,200 | 4,200 | 4,200 | 4,400 |
| (280° C., 10 s⁻¹) | | | | | | | |
| Branching ratio | | mol % | 0.63 | 0.63 | 0.63 | 0.63 | 1.61 |
| Diphosphite | | | | | | | |
| compound (B) | | | | | | | |
| | Dover28 | part(s) | 0.05 | 0.05 | 0.05 | 0.05 | 0.05 |
| | | by mass | | | | | |
| Other compounds | | | | | | | |
| (C) | EFTOP KFBS | part(s) | 0.10 | 0.10 | 0.10 | 0.10 | 0.10 |
| | | by mass | | | | | |
| (D) | PEG-PPG | part(s) | | | | 0.20 | 0.50 |
| | | by mass | | | | | |
| (E) | D210C (PTFE) | part(s) | 0.10 | 0.10 | 0.10 | 0.10 | 0.10 |
| | | by mass | | | | | |
| (F) | 2021P (alicyclic | part(s) | | | | 0.03 | 0.03 |
| | epoxy) | by mass | | | | | |
| (G1) | ChemiSorb 79 | part(s) | 0.20 | | | | |
| | | by mass | | | | | |
| (G2) | UV-3638 | part(s) | | 0.15 | 0.15 | 0.15 | 0.15 |
| | | by mass | | | | | |
| (H) | KMP590 | part(s) | | | | | |
| | | by mass | | | | | |
| Antioxidant | Irg 168 | part(s) | | | 0.03 | | |
| | | by mass | | | | | |
| | PEP-36 | part(s) | | | | | |
| | | by mass | | | | | |
| Viscosity-average | | | 23,010 | 23,010 | 23,010 | 23,010 | 23,150 |
| molecular weight of | | | | | | | |
| resin composition (Mv) | | | | | | | |
| Flame retardancy (UL94-1 mmt) | | | V-0 | V-0 | V-0 | V-0 | V-0 |
| Initial YI₁ (1 mmt) (310° C.) | | | 3.3 | 2.9 | 2.9 | 2.6 | 2.4 |
| Initial YI evaluation | | | A | AA | AA | AA | AA |
| 85° C. 85% | YI₂⁵⁰⁰ (500 hr) | | 3.5 | 3.0 | 3.0 | 2.6 | 2.5 |
| RH (1 mmt) | YI₂¹⁰⁰⁰ (1,000 hr) | | 4.1 | 3.3 | 3.1 | 3.2 | 3.1 |
| Moisture resistance and | | | A/C | AA/A | AA/A | AA/A | AA/A |
| heat resistance | | | | | | | |
| evaluation: YI₂⁵⁰⁰/YI₂¹⁰⁰⁰ | | | | | | | |
| 120° C. YI | YI₃ (1,000 hr) | | 4.2 | 3.2 | 3.2 | 2.9 | 3.1 |
| (1 mmt) | | | | | | | |
| Heat resistance | | | C | A | A | AA | A |
| evaluation | | | | | | | |
| 85° C. 85% | Δ(YI₂⁵⁰⁰ − YI₁) | | 0.2 | 0.1 | 0.1 | 0.0 | 0.1 |
| RH (ΔYI) | Δ(YI₂¹⁰⁰⁰ − YI₁) | | 0.8 | 0.4 | 0.2 | 0.6 | 0.7 |
| Moisture resistance and | | | AA/A | AA/AA | AA/AA | AA/A | AA/A |
| heat resistance evaluation: | | | | | | | |
| Δ(YI₂⁵⁰⁰ − YI₁)/ | | | | | | | |
| Δ(YI₂¹⁰⁰⁰ − YI₁) | | | | | | | |
| 120° C. (ΔYI) | Δ(YI₃ − YI₁) | | 0.9 | 0.3 | 0.3 | 0.3 | 0.7 |
| Heat resistance evaluation (ΔYI) | | | A | AA | AA | AA | A |
| | | | | | | Comparative | |
| | | | Example | | | Example | |
| | | | 1-6 | 1-7 | 1-8 | 1-1 | 1-2 |
| PC-based resin (A) | | | | | | | |
| (A-1) | Branched PC1 | mass % | | | | | 70 |
| | (2.3 mol %) | | | | | | |
| | Branched PC2 | mass % | 70 | 70 | 70 | 70 | |
| | (0.9 mol %) | | | | | | |
| (A-2) | FN2500A | mass % | 30 | 30 | | 30 | 30 |
| | FN1700 | mass % | | | 30 | | |
| Melt viscosity | | Pa · s | 4,200 | 4,200 | 3,400 | 4,200 | 4,400 |
| (280° C., 10 s⁻¹) | | | | | | | |
| Branching ratio | | mol % | 0.63 | 0.63 | 0.63 | 0.63 | 1.61 |
| Diphosphite | | | | | | | |
| compound (B) | | | | | | | |
| | Dover28 | part(s) | 0.05 | 0.05 | 0.05 | | |
| | | by mass | | | | | |
| Other compounds | | | | | | | |
| (C) | EFTOP KFBS | part(s) | 0.10 | 0.10 | 0.10 | 0.10 | 0.10 |
| | | by mass | | | | | |
| (D) | PEG-PPG | part(s) | 0.50 | 0.20 | | | |
| | | by mass | | | | | |
| (E) | D210C (PTFE) | part(s) | 0.10 | 0.10 | 0.10 | 0.10 | 0.10 |
| | | by mass | | | | | |
| (F) | 2021P (alicyclic | part(s) | 0.03 | 0.03 | | | |
| | epoxy) | by mass | | | | | |
| (G1) | ChemiSorb 79 | part(s) | | | | 0.20 | 0.20 |
| | | by mass | | | | | |
| (G2) | UV-3638 | part(s) | 0.15 | 0.15 | | | |
| | | by mass | | | | | |
| (H) | KMP590 | part(s) | | 2.00 | | | |
| | | by mass | | | | | |
| Antioxidant | Irg 168 | part(s) | | | 0.03 | 0.05 | 0.05 |
| | | by mass | | | | | |
| | PEP-36 | part(s) | | | | | |
| | | by mass | | | | | |
| Viscosity-average | | | 23,010 | 23,010 | 21,270 | 23,010 | 23,150 |
| molecular weight of | | | | | | | |
| resin composition (Mv) | | | | | | | |
| Flame retardancy (UL94-1 mmt) | | | V-1 | V-0 | V-0 | V-0 | V-0 |
| Initial YI₁ (1 mmt) (310° C.) | | | 2.3 | 2.6 | 2.6 | 3.7 | 3.9 |
| Initial YI evaluation | | | AA | AA | AA | B | B |
| 85° C. 85% | YI₂⁵⁰⁰ (500 hr) | | 2.4 | 2.9 | 2.6 | 3.7 | 3.9 |
| RH (1 mmt) | YI₂¹⁰⁰⁰ (1,000 hr) | | 3.1 | 3.1 | 2.8 | 4.2 | 4.6 |
| Moisture resistance and | | | AA/A | AA/A | AA/AA | B/C | B/D |
| heat resistance | | | | | | | |
| evaluation: YI₂⁵⁰⁰/YI₂¹⁰⁰⁰ | | | | | | | |
| 120° C. YI | YI₃ (1,000 hr) | | 3.1 | 3.9 | 2.9 | 4.5 | 4.8 |
| (1 mmt) | | | | | | | |
| Heat resistance | | | A | B | AA | C | D |
| evaluation | | | | | | | |
| 85° C. 85% | Δ(YI₂⁵⁰⁰ − YI₁) | | 0.1 | 0.3 | 0.0 | 0.0 | 0.0 |
| RH (ΔYI) | Δ(YI₂¹⁰⁰⁰ − YI₁) | | 0.8 | 0.5 | 0.2 | 0.5 | 0.7 |
| Moisture resistance and | | | AA/A | AA/A | AA/AA | AA/A | AA/A |
| heat resistance evaluation: | | | | | | | |
| Δ(YI₂⁵⁰⁰ − YI₁)/ | | | | | | | |
| Δ(YI₂¹⁰⁰⁰ − YI₁) | | | | | | | |
| 120° C. (ΔYI) | Δ(YI₃ − YI₁) | | 0.8 | 1.3 | 0.3 | 0.8 | 0.9 |

| | | | | | |
|---|---|---|---|---|---|
| Heat resistance evaluation (ΔYI) | A | B | AA | A | A |

### Examples 1-9 to 1-13 and Comparative Examples 1-3 and 1-4

Respective components were mixed at ratios shown in Table 2, and each of the mixtures was supplied to a vented twin-screw extrusion molding machine [manufactured by Toshiba Machine Co., Ltd.: TEM37SS], and was melt-kneaded at a barrel temperature of from 270° C. to 280° C., a screw revolution number of 300 rpm, and an ejection amount of 50 kg/hr to provide an evaluation pellet sample. The resultant pellet was dried at 120° C. for 5 hours, and then subjected to various evaluations. Various YI value evaluations were performed as described below. The results are shown in Table 2.

### (5′-1) Initial YI Value of Molded Article

A YI value (initial YI value: YI₁) was measured under the same conditions as in (5-1) above. The results are shown in Table 2. Evaluation was performed as follows: a case in which the YI₁ was 4.0 or less was graded AA, a case in which the YI₁ was more than 4.0 and 5.0 or less was graded A, and a case in which the YI₁ was more than 5.0 was graded B.

### (5′-2) Moist Heat Resistance Test of Molded Article

The flat plate-shaped test piece after the YI₁ measurement was treated under the same conditions as in (5-2) above, and was measured for each of its YI value after 500 hours (YI₂⁵⁰⁰) and YI value after 1,000 hours (YI₂¹⁰⁰⁰). The results are shown in Table 2. Evaluation was performed as follows: a case in which each of the YI₂⁵⁰⁰ and the YI₂¹⁰⁰⁰ was 4.0 or less was graded AA, a case in which each thereof was more than 4.0 and 5.0 or less was graded A, a case in which each thereof was more than 5.0 and 6.0 or less was graded B, and a case in which each thereof was more than 6.0 was graded C.

### (5′-3) Heat Resistance Test of Molded Article

The flat plate-shaped test piece after the YI₁ measurement was treated in the same manner as in (5-3) above, and was measured for its YI value after 1,000 hours (YI₃). The results are shown in Table 2. A case in which the YI₃ was 4.0 or less was graded AA, a case in which the YI₃ was more than 4.0 and 5.0 or less was graded A, a case in which the YI₃ was more than 5.0 and 6.0 or less was graded B, a case in which the YI₃ was more than 6.0 and 7.0 or less was graded C, and a case in which the YI₃ was more than 7.0 was graded D.

### (5′-4) Moist Heat Resistance Evaluation (ΔYI) of Molded Article

The moist heat resistance evaluation of a molded article was performed in the same manner as in (5-4) above. The results are shown in Table 2. Determination criteria for the moist heat resistance evaluation were as follows: a case in which each of Δ(YI₂⁵⁰⁰−YI₁) and Δ(YI₂¹⁰⁰⁰−YI₁) was 0.4 or less was graded AA, a case in which each thereof was more than 0.4 and 0.9 or less was graded A, a case in which each thereof was more than 0.9 and 1.4 or less was graded B, a case in which each thereof was more than 1.4 and 1.9 or less was graded C, and a case in which each thereof was more than 1.9 was graded D.

### (5′-5) Heat Resistance Evaluation (ΔYI) of Molded Article

The heat resistance evaluation of a molded article was performed in the same manner as in (5-5) above. The results are shown in Table 2. Determination criteria for the heat resistance evaluation were as follows: a case in which Δ(YI₃−YI₁) was 0.4 or less was graded AA, a case in which Δ(YI₃−YI₁) was more than 0.4 and 0.9 or less was graded A, a case in which Δ(YI₃−YI₁) was more than 0.9 and 1.4 or less was graded B, a case in which Δ(YI₃−YI₁) was more than 1.4 and 1.9 or less was graded C, and a case in which Δ(YI₃−YI₁) was more than 1.9 was graded D.

TABLE 2

| | | | | Example | | | | | Comparative Example | |
|---|---|---|---|---|---|---|---|---|---|---|
| | | | | 1-9 | 1-10 | 1-11 | 1-12 | 1-13 | 1-3 | 1-4 |
| PC-based resin (A) | | | | | | | | | | |
| (A-1) | Branched PC1 | | mass % | | | | | | | |
| | (2.3 mol %) | | | | | | | | | |
| | Branched PC2 | | mass % | 70 | 70 | 70 | 40 | 40 | 70 | |
| | (0.9 mol %) | | | | | | | | | |
| (A-2) | FN2500 | | mass % | 30 | 30 | 30 | 60 | 60 | 30 | 100 |
| Melt viscosity (280° C., 10 s⁻¹) | | | Pa · s | 4,200 | 4,200 | 4,200 | 3,700 | 3,700 | 4,200 | 2,900 |
| Branching ratio | | | mol % | 0.63 | 0.63 | 0.63 | 0.36 | 0.36 | 0.63 | 0.00 |
| Diphosphite compound (B) | | | | | | | | | | |
| | Dover28 | | part(s) | 0.10 | 0.05 | 0.05 | 0.05 | 0.10 | | 0.10 |
| | | | by mass | | | | | | | |
| Other compounds | | | | | | | | | | |
| (C) | EFTOP KFBS | | part(s) | 0.10 | 0.10 | 0.10 | 0.10 | 0.10 | 0.10 | 0.10 |
| | | | by mass | | | | | | | |
| (D) | PEG-PPG | | part(s) | 0.20 | | | | | | |
| | | | by mass | | | | | | | |
| (E) | D210C (PTFE) | | part(s) | 0.15 | 0.15 | 0.15 | 0.15 | 0.15 | 0.15 | 0.15 |
| | | | by mass | | | | | | | |
| (F) | 2021P (alicyclic | | part(s) | 0.05 | 0.05 | | 0.05 | | | |
| | epoxy) | | by mass | | | | | | | |
| (G1) | ChemiSorb 79 | | part(s) | | | | | | | |
| | | | by mass | | | | | | | |
| (G2) | UV-3638 | | part(s) | | 0.20 | | | | | |
| | | | by mass | | | | | | | |
| (H) | KMP590 | | part(s) | | 1.50 | | | | | |
| | | | by mass | | | | | | | |
| Antioxidant | Irg 168 | | part(s) | | 0.03 | | 0.03 | | 0.05 | |
| | | | by mass | | | | | | | |
| | PEP-36 | | part(s) | | | | | | | |
| | | | by mass | | | | | | | |
| Viscosity-average molecular | | | | 23,010 | 23,010 | 23,010 | 23,220 | 23,220 | 23,010 | 23,500 |
| weight of resin | | | | | | | | | | |
| composition (Mv) | | | | | | | | | | |
| Flame retardancy | 1.0 | mmt | | V-0 | V-0 | V-0 | V-0 | V-0 | V-0 | V-2 |
| (UL94) | 0.75 | mmt | | V-1 | V-0 | V-0 | V-1 | V-1 | V-0 | V-2 |

| Initial YI₁ (1 mmt) (310° C.) | | 3.7 | 2.5 | 4.6 | 4.5 | 4.5 | 5.1 | 4.7 |
|---|---|---|---|---|---|---|---|---|
| Initial YI evaluation | | AA | AA | A | A | A | B | A |
| 85° C. 85% | YI₂⁵⁰⁰ (500 hr) | 4.6 | 2.9 | 5.3 | 4.7 | 5.1 | 5.7 | 5.4 |
| RH (1 mmt) | YI₂¹⁰⁰⁰ (1,000 hr) | 5.0 | 3.2 | 6.2 | 5.0 | 6.0 | 6.5 | 6.2 |
| Moisture resistance and heat | | A/A | AA/AA | B/C | A/A | B/B | B/C | B/C |
| resistance evaluation: | | | | | | | | |
| YI₂⁵⁰⁰/YI₂¹⁰⁰⁰ | | | | | | | | |
| 120° C. YI | YI₃ (1,000 hr) | 5.3 | 3.8 | 6.5 | 5.4 | 6.5 | 7.5 | 6.7 |
| (1 mmt) | | | | | | | | |
| Heat resistance evaluation | | B | AA | C | B | C | D | C |
| 85° C. 85% | Δ(YI₂⁵⁰⁰ − YI₁) | 0.9 | 0.4 | 0.7 | 0.2 | 0.6 | 0.6 | 0.7 |
| RH (ΔYI) | Δ(YI₂¹⁰⁰⁰ − YI₁) | 1.3 | 0.7 | 1.6 | 0.5 | 1.5 | 1.4 | 1.5 |
| Moisture resistance and heat | | A/B | AA/A | A/C | AA/A | A/C | A/B | A/C |
| resistance evaluation: | | | | | | | | |
| Δ(YI₂⁵⁰⁰ − YI₁)/ | | | | | | | | |
| Δ(YI₂¹⁰⁰⁰ − YI₁) | | | | | | | | |
| 120° C. (ΔYI) | Δ(YI₃ − YI₁) | 1.6 | 1.3 | 1.9 | 0.9 | 2.0 | 2.4 | 2.0 |

| | | | | | | | |
|---|---|---|---|---|---|---|---|
| Heat resistance evaluation (ΔYI) | C | B | C | A | D | D | D |

### Examples 2-1 to 2-5 and Comparative Examples 2-1 to 2-4

Respective components were mixed at ratios shown in Table 3, and each of the mixtures was supplied to a vented twin-screw extrusion molding machine [manufactured by Toshiba Machine Co., Ltd.: TEM35], and was melt-kneaded at a barrel temperature of from 270° C. to 280° C., a screw revolution number of 300 rpm, and an ejection amount of 50 kg/hr to provide an evaluation pellet sample. The resultant pellet was dried at 120° C. for 5 hours, and then subjected to various evaluations. The various YI value evaluations were performed as follows. The results are shown in Table 3.

### (5″-1) Initial YI Value of Molded Article

A YI value (initial YI value: YI₁) was measured under the same conditions as in (5-1) above. The results are shown in Table 3. Evaluation was performed as follows: a case in which the YI₁ was less than 1.0 was graded AA, a case in which the YI₁ was from 1.0 to 1.4 was graded A, and a case in which the YI₁ was more than 1.4 was graded B.

### (5″-2) Moist Heat Resistance Test of Molded Article

Measurement is as described in (5-2). Evaluation was performed as follows: a case in which each of YI₃⁵⁰⁰ and YI₃¹⁰⁰⁰ was 1.5 or less was graded AA, a case in which each thereof was more than 1.5 and 2.0 or less was graded A, a case in which each thereof was more than 2.0 and 2.5 or less was graded B, a case in which each thereof was more than 2.5 and 4.0 or less was graded C, and a case in which each thereof was more than 4.0 was graded D.

### (5″-3) Heat Resistance Test of Molded Article

The flat plate-shaped test piece after the YI₁ measurement was treated under the same conditions as in (5-3) above, and was measured for its YI value after 1,000 hours (YI₃). The results are shown in Table 3. A case in which the YI₃ was 2.0 or less was graded A, a case in which the YI₃ was more than 2.0 and 3.0 or less was graded B, a case in which the YI₃ was more than 3.0 and 4.0 or less was graded C, and a case in which the YI₃ was more than 4.0 was graded D.

### (5″-4) Heat Resistance Evaluation of Molded Article and (5″-5) Moist Heat Resistance Evaluation (ΔYI) of Molded Article

Evaluations were performed in the same manner as in (5-4) and (5-5). Determination criteria are as described below. Moist heat resistance evaluation was performed as follows: a case in which each of Δ(YI₂⁵⁰⁰−YI₁) and Δ(YI₂¹⁰⁰⁰−YI₁) was 0.4 or less was graded AA, a case in which each thereof was more than 0.4 and 0.9 or less was graded A, a case in which each thereof was more than 0.9 and 1.4 or less was graded B, a case in which each thereof was more than 1.4 and 1.9 or less was graded C, a case in which each thereof was more than 1.9 and 2.4 or less was graded D, and a case in which each thereof was more than 2.4 was graded E. Heat resistance evaluation was performed as follows: a case in which Δ(YI₃−YI₁) was 0.4 or less was graded AA, a case in which Δ(YI₃−YI₁) was more than 0.4 and 0.9 or less was graded A, a case in which Δ(YI₃−YI₁) was more than 0.9 and 1.4 or less was graded B, a case in which Δ(YI₃−YI₁) was more than 1.4 and 1.9 or less was graded C, a case in which Δ(YI₃−YI₁) was more than 1.9 and 2.4 or less was graded D, and a case in which Δ(YI₃−YI₁) was more than 2.4 was graded E.

TABLE 3

| | | | Example | | | | |
|---|---|---|---|---|---|---|---|
| | | | 2-1 | 2-2 | 2-3 | 2-4 | 2-5 |
| PC-based resin (A) | | | | | | | |
| (A-1) | Branched PC1 | mass % | | | | 100 | |
| | (2.3 mol %) | | | | | | |
| | Branched PC2 | mass % | 100 | 100 | 100 | | 100 |
| | (0.9 mol %) | | | | | | |
| (A-2) | FN2500 | mass % | | | | | |
| Melt viscosity (280° C., 10 s⁻¹) | | Pa · s | 4,800 | 4,800 | 4,800 | 5,100 | 4,800 |
| Branching ratio | | mol % | 0.9 | 0.9 | 0.9 | 2.3 | 0.9 |
| Diphosphite compound (B) | | | | | | | |
| | Dover28 | part(s) | 0.10 | 0.10 | 0.10 | 0.10 | 0.20 |
| | | by mass | | | | | |
| Other compounds | | | | | | | |
| (C) | EFTOP KFBS | part(s) | 0.10 | 0.10 | 0.10 | 0.10 | 0.10 |
| | | by mass | | | | | |
| (D) | PEG-PPG | part(s) | | | | | |
| | | by mass | | | | | |
| (E) | D210C (PTFE) | part(s) | | | | | |
| | | by mass | | | | | |
| (F) | 2021P (alicyclic | part(s) | 0.01 | 0.10 | | | |
| | epoxy) | by mass | | | | | |
| (G1) | ChemiSorb 79 | part(s) | | | | | |
| | | by mass | | | | | |
| (G2) | UV3638 | part(s) | | | | | |
| | | by mass | | | | | |
| (H) | KMP590 | part(s) | | | | | |
| | | by mass | | | | | |
| Antioxidant | IRGAFOS 168 | part(s) | | | | | |
| | | by mass | | | | | |
| | PEP-36 | part(s) | | | | | |
| | | by mass | | | | | |
| Viscosity-average molecular | | | 22,800 | 22,800 | 22,800 | 23,000 | 22,800 |
| weight of resin | | | | | | | |
| composition (Mv) | | | | | | | |
| Flame retardancy (UL94-1 mmt) | | | V-0 | V-0 | V-0 | V-0 | V-0 |
| Initial YI₁ (1 mmt) (310° C.) | | | 1.1 | 1.2 | 1.2 | 1.3 | 1.2 |
| Initial YI evaluation | | | A | A | A | A | A |
| 85° C. 85% RH (1 mmt) | YI₂⁵⁰⁰ (500 hr) | | 1.2 | 1.3 | 2.0 | 2.1 | 2.0 |
| | YI₂¹⁰⁰⁰ (1,000 hr) | | 1.4 | 1.3 | 3.3 | 3.6 | 3.1 |
| Moisture resistance and | | | AA/AA | AA/AA | A/C | B/C | A/C |
| heat resistance | | | | | | | |
| evaluation: YI₂⁵⁰⁰/YI₂¹⁰⁰⁰ | | | | | | | |
| 120° C. YI (1 mmt) | YI₃ (1,000 hr) | | 2.0 | 1.8 | 2.9 | 3.0 | 2.9 |
| Heat resistance evaluation | | | A | A | B | B | B |
| 85° C. 85% RH (ΔYI) | Δ(YI₂⁵⁰⁰ − YI₁) | | 0.1 | 0.1 | 0.8 | 0.8 | 0.8 |
| | Δ(YI₂¹⁰⁰⁰ − YI₁) | | 0.3 | 0.1 | 2.1 | 2.3 | 1.9 |
| Moisture resistance and | | | AA/AA | AA/AA | A/D | A/D | A/C |
| heat resistance evaluation: | | | | | | | |
| Δ(YI₂⁵⁰⁰ − YI₁)/Δ(YI₂¹⁰⁰⁰ − YI₁) | | | | | | | |
| 120° C. (ΔYI) | Δ(YI₃ − YI₁) | | 0.9 | 0.6 | 1.7 | 1.7 | 1.7 |

| | | | | | |
|---|---|---|---|---|---|
| Heat resistance evaluation (ΔYI) | A | A | C | C | C |

| | | | Comparative Example | | | |
|---|---|---|---|---|---|---|
| | | | 2-1 | 2-2 | 2-3 | 2-4 |
| PC-based resin (A) | | | | | | |
| (A-1) | Branched PC1 | mass % | | | | |
| | (2.3 mol %) | | | | | |
| | Branched PC2 | mass % | | | 100 | 100 |
| | (0.9 mol %) | | | | | |
| (A-2) | FN2500 | mass % | 100 | 100 | | |
| Melt viscosity (280° C., 10 s⁻¹) | | Pa · s | 2,900 | 2,900 | 4,800 | 4,800 |
| Branching ratio | | mol % | 0.0 | 0.0 | 0.9 | 0.9 |
| Diphosphite compound (B) | | | | | | |
| | Dover28 | part(s) | 0.10 | | | |
| | | by mass | | | | |
| Other compounds | | | | | | |
| (C) | EFTOP KFBS | part(s) | 0.10 | 0.10 | 0.10 | 0.10 |
| | | by mass | | | | |
| (D) | PEG-PPG | part(s) | | | | |
| | | by mass | | | | |
| (E) | D210C (PTFE) | part(s) | | | | |
| | | by mass | | | | |
| (F) | 2021P (alicyclic | part(s) | 0.01 | | | |
| | epoxy) | by mass | | | | |
| (G1) | ChemiSorb 79 | part(s) | | | | |
| | | by mass | | | | |
| (G2) | UV3638 | part(s) | | | | |
| | | by mass | | | | |
| (H) | KMP590 | part(s) | | | | |
| | | by mass | | | | |
| Antioxidant | IRGAFOS 168 | part(s) | | | 0.10 | |
| | | by mass | | | | |
| | PEP-36 | part(s) | | 0.10 | | 0.10 |
| | | by mass | | | | |
| Viscosity-average molecular | | | 23,500 | 23,500 | 22800 | 22800 |
| weight of resin | | | | | | |
| composition (Mv) | | | | | | |
| Flame retardancy (UL94-1 mmt) | | | V-2 | V-2 | V-0 | V-0 |
| Initial YI₁ (1 mmt) (310° C.) | | | 1.1 | 1.1 | 1.5 | 1.7 |
| Initial YI evaluation | | | A | A | B | B |
| 85° C. 85% RH (1 mmt) | YI₂⁵⁰⁰ (500 hr) | | 1.1 | 1.8 | 2.4 | 2.6 |
| | YI₂¹⁰⁰⁰ (1,000 hr) | | 1.2 | 3.7 | 3.5 | 4.5 |
| Moisture resistance and | | | AA/AA | A/C | B/C | C/D |
| heat resistance | | | | | | |
| evaluation: YI₂⁵⁰⁰/YI₂¹⁰⁰⁰ | | | | | | |
| 120° C. YI (1 mmt) | YI₃ (1,000 hr) | | 1.7 | 2.7 | 3.5 | 4.2 |
| Heat resistance evaluation | | | A | B | C | D |
| 85° C. 85% RH (ΔYI) | Δ(YI₂⁵⁰⁰ − YI₁) | | 0.0 | 0.7 | 0.9 | 0.9 |
| | Δ(YI₂¹⁰⁰⁰ − YI₁) | | 0.1 | 2.6 | 2.0 | 2.8 |
| Moisture resistance and | | | AA/AA | A/E | A/D | A/E |
| heat resistance evaluation: | | | | | | |
| Δ(YI₂⁵⁰⁰ − YI₁)/Δ(YI₂¹⁰⁰⁰ − YI₁) | | | | | | |
| 120° C. (ΔYI) | Δ(YI₃ − YI₁) | | 0.6 | 1.6 | 2.0 | 2.5 |

| | | | | |
|---|---|---|---|---|
| Heat resistance evaluation (ΔYI) | A | C | D | E |

It is found from the results of Tables 1 to 3 that the polycarbonate-based resin composition of the present invention has a low YI value, and hence has an excellent color tone, and is also excellent in thin-wall flame retardancy at a thickness of 1 mm. In particular, in the system of each of Examples 1-9 to 1-13, excellent flame retardancy has been achieved even at a thickness of 0.75 mm, and hence high-level thin-wall flame retardancy can be obtained.

With regard to the color tone, it is further found that the polycarbonate-based resin composition of the present invention, in addition to being excellent in initial YI value, maintains excellent YI values even after the moisture resistance and heat resistance test and the heat resistance test, and is excellent in moist heat resistance as well as heat resistance also in terms of ΔYI values.

### Industrial Applicability

As described in detail above, through use of the polycarbonate resin composition of the present invention, there is obtained a polycarbonate resin molded article excellent in color tone and having excellent flame retardancy, in particular, thin-wall flame retardancy. Accordingly, the polycarbonate resin molded article of the present invention is useful as a cover for lighting equipment, a diffusion cover for display equipment, a diffusion plate for display equipment, such as a diffusion plate for a liquid crystal display, and a lens.

1. A polycarbonate-based resin composition, consisting of:
a polycarbonate-based resin (A) having a branching ratio of 0.01 mol % or more and 3.0 mol % or less,
a diphosphite compound (B) represented by the following general formula (I),
one or more selected from the group consisting of
(i-1) 0.001 part by mass or more and 1 part by mass or less of at least one kind selected from the group consisting of an organic alkali metal salt and an organic alkaline earth metal salt (C) with respect to 100 parts by mass of the polycarbonate-based resin (A),
(i-2) polytetrafluoroethylene (E),
(i-3) 0.02 part by mass or more and 2.0 parts by mass or less of a polyether (D) having a polyoxyalkylene structure with respect to 100 parts by mass of the polycarbonate-based resin (A),
(i-4) an alicyclic epoxy compound (F),
(i-5) a UV absorber (G),
(i-6) a diffuser (H), and
(i-7) a phosphorus-based antioxidant other than the diphosphite compound (B) represented by the formula (I);
wherein a content of the diphosphite compound (B) is from 0.005 part by mass to 0.5 part by mass with respect to 100 parts by mass of the polycarbonate-based resin (A): 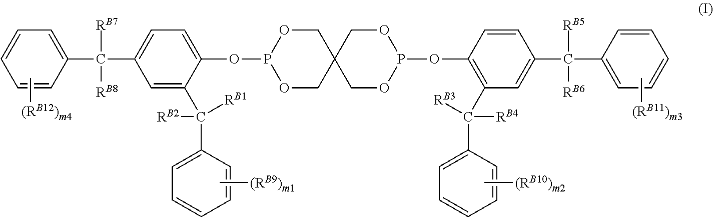
wherein:
R^{B1} to R^{B8} each independently represent an alkyl group or an alkenyl group, and may be identical to or different from each other;
R^{B1} and R^{B2}, R^{B3} and R^{B4}, R^{B5} and R^{B6}, or R^{B7} and R^{B8} may be bonded to each other to form a ring;
R^{B9}, R^{B10}, R^{B11}, and R^{B12} each independently represent a hydrogen atom or an alkyl group, and may be identical to or different from each other;
m1 to m4 each represent an integer of 0 or more and 5 or less, and may be identical to or different from each other; and
when any one of m1 to m4 represents 2 or more, a plurality of R^{B9}, R^{B10}, R^{B11}, or R^{B12} may be identical to or different from each other.

2. The polycarbonate-based resin composition according to claim 1, wherein the polycarbonate-based resin (A) is formed of 10 mass % to 100 mass % of a branched polycarbonate-based resin (A-1) and 0 mass % to 90 mass % of an aromatic polycarbonate-based resin (A-2) except the (A-1).

3. The polycarbonate-based resin composition according to claim 1, wherein the polycarbonate-based resin (A) has a melt viscosity at 280° C. and a shear rate of 10 s⁻¹ of from 3,000 Pa·s to 6,000 Pa·s.

4. The polycarbonate-based resin composition according to claim 1, wherein the polycarbonate-based resin (A) has a viscosity-average molecular weight of from 10,000 to 50,000.

5. The polycarbonate-based resin composition according to claim 1, wherein the polycarbonate-based resin composition contains the polytetrafluoroethylene (E), and
wherein the polytetrafluoroethylene (E) is an aqueous dispersion-type or acryl-coated polytetrafluoroethylene

6. The polycarbonate-based resin composition according to claim 1, wherein the polycarbonate-based resin composition contains the alicyclic epoxy compound (F), and
wherein the alicyclic epoxy compound (F) is 3′,4′-epoxycyclohexylmethyl-3,4-epoxycyclohexanecarboxylate.

7. The polycarbonate-based resin composition according to claim 1, wherein the polycarbonate-based resin composition has a flame retardancy of V-0 under a UL94 standard when molded to have a thickness of 1.0 mm.

8. The polycarbonate-based resin composition according to claim 1, wherein the polycarbonate-based resin composition is free of any polytetrafluoroethylene.

9. The polycarbonate-based resin composition according to claim 8, wherein the polycarbonate-based resin composition has an initial YI value of 1.3 or less when molded to have a thickness of 1.0 mm.

10. The polycarbonate-based resin composition according to claim 1,
wherein a content of a polytetrafluoroethylene (E) is 0.10 part by mass or less, and
wherein the polycarbonate-based resin composition has an initial YI value of 3.5 or less when molded to have a thickness of 1.0 mm.

11. The polycarbonate-based resin composition according to claim 1,
wherein a content of a polytetrafluoroethylene (E) is 0.15 part by mass or less, and
wherein the polycarbonate-based resin composition has an initial YI value of 4.6 or less when molded to have a thickness of 1.0 mm.

12. A molded article, comprising the polycarbonate-based resin composition of claim 1.

13. The polycarbonate-based resin composition according to claim 1, wherein the branching ratio is 0.5 mol % or more and 3.0 mol % or less.

14. The polycarbonate-based resin composition according to claim 1, consisting of:
the polycarbonate-based resin (A),
the diphosphite compound (B),
the salt (C),
the polytetrafluoroethylene (E), and
optionally one or more selected from the group consisting of
the polyether (D) having a polyoxyalkylene structure with respect to 100 parts by mass of the polycarbonate-based resin (A),
the alicyclic epoxy compound (F),
the UV absorber (G), and
the phosphorus-based antioxidant other than the diphosphite compound (B) represented by the formula (I).
